(19) United States
(12) Patent Application Publication
(10) Pub. No.: US 2015/0070693 A1
(43) Pub. Date: Mar. 12, 2015

(54) ANALYSIS DEVICE, ANALYSIS METHOD, OPTICAL ELEMENT USED FOR THE SAME, AND ELECTRONIC APPARATUS

(71) Applicant: Seiko Epson Corporation, Tokyo (JP)

(72) Inventors: Mamoru SUGIMOTO, Chino (JP); Tetsuo MANO, Chino (JP); Megumi ENARI, Suwa (JP)

(21) Appl. No.: 14/479,660

(22) Filed: Sep. 8, 2014

(30) Foreign Application Priority Data
Sep. 10, 2013 (JP) 2013-187209

(51) Int. Cl. G01N 21/55; G01N 21/65; G01N 21/21

(52) U.S. Cl. CPC G01N 21/55; G01N 21/21; G01N 21/658
USPC 356/301; 356/445; 356/369

(57) ABSTRACT

An analysis device is provided with an optical element having a structure in which the end portions of the upper surface and the lower surface of second metal layers are capable of having contact with a measurement object, and hotspots are exposed on the element surfaces. Therefore, it is easy for the substance that is the analysis object to be located at the hotspot. Further, since a first metal layer is disposed in the vicinity of the second metal layers, a resonance effect of a localized surface plasmon and a propagating surface plasmon can be generated. Therefore, the enhancement degree of light based on the plasmon is extremely high, and it is possible to analyze the substance with extremely high sensitivity.

### BACKGROUND

1. Technical Field

The present invention relates to an analysis device, an analysis method, an optical element used for the analysis device and an analysis method, and an electronic apparatus.

2. Related Art

In the fields of environment, food, public security, and so on including a field of medical services and health, there has been demanded a sensing technology for sensitively, accurately, promptly, and easily detecting a trace substance. A wide variety of substances are used as the minute amount of substance to be the object of sensing, and for example, a biologically-relevant substance such as bacteria, virus, protein, nucleic acid, a variety of antigens/antibodies, and a variety of compounds including inorganic molecules, organic molecules, or polymers become the object of sensing. In the past, although detection of a trace substance has been performed through sampling, a rough analysis, and a detailed analysis, since a dedicated device has been necessary, and proficiency of an inspection operator has been required, an in-situ analysis has been difficult inmost cases. Therefore, it has taken a long period (more than a few days) to obtain the inspection result. In sensing technologies, a demand for being prompt and easy is very strong, and it is desired to develop a sensor capable of meeting the demand. For example, diagnosis of a patient presenting with vomiting, diarrhea, or fever in an airport or the like is a matter of emergency from the viewpoint of preventing an infection spread. Further, since the treatment is different between the bacteria and the virus, and further, from the viewpoint of breaking the infection route, it is important for an infection inspection to promptly identify the type of the bacteria or the virus.

In view of such a request, in recent years, a variety of types of sensors including sensors using an electrochemical method have been studied, and sensors using surface plasmon resonance (SPR) have drawn increasing attention on the grounds of possibility of integration, low cost, and tolerance for a measurement environment. For example, it is known to detect the presence or absence of adsorption of a substance such as adsorption of an antigen in an antigen-antibody reaction using the SPR generated in a metal thin film disposed on a surface of a total reflection prism. Further, there has also been studied a method of, for example, detecting the Raman scattering of a substance attached to a sensor region to thereby identify the attached substance using surface enhanced Raman scattering (SERS).

As a structure of such a sensor, there are proposed some possible structures in, for example, OPTICS TELLERS, Vol. 34, No. 3, 2009, pp. 244-246 (OPTICS TELLERS) and OPTICS EXPRESS, Vol. 19, No. 5, 2011, pp. 3925-3936 (OPTICS EXPRESS). In OPTICS TELLERS, there is proposed a hybrid structure for causing a propagating surface plasmon (PSP) in an X-Y direction (a direction parallel to a substrate surface) in addition to a localized surface plasmon (LSP) represented by a Gap type surface plasmon polariton (GSPP) model. In OPTICS EXPRESS, there is proposed a Disk-coupled dots-on-pillar antenna model (D2PA model) as a structure with an increased hotspot density (HSD).

In the structure disclosed in OPTICS EXPRESS, there is adopted a method of using a localized surface plasmon generated in a gap (a nano-gap) between gold nanoparticles grown on a side surface of a pillar formed of SiO₂. According to FIG. 4 of the literature, the enhancement degree of the electric field fulfills |E⁴/E₀⁴|≈10⁵, namely |E|≈17.8|E₀|, in the case in which no nanoparticle exists, and fulfills |E⁴/E₀⁴|10⁷, namely |E|≈56.2|E₀|, in the case in which thenanoparticle exists on the side surface of the pillar.

Meanwhile, JP-A-2009-085724 discloses a target substance detection device having metal structures formed directly on a substrate. In the device of JP-A-2009-085724, the metal structures are arranged in a matrix so that the distance between the metal structures in one direction of the matrix is shorter than the distance between the metal structures in the other direction of the matrix. Further, it is arranged that the shorter distance is equal to or smaller than 1/10 of the resonant frequency, polarized light in the direction with the shorter distance is input, and the longer distance is in a range from ¼ of the resonant frequency to the resonant frequency. Further, in paragraph 0008 of JP-A-2009-085724, there is described a problem that if the distance between the metal structures is decreased, the enhancement degree of the electric field can be increased, but the peak width of the absorption spectrum is broadened, and in paragraph 0018 and so on of JP-A-2009-085724, there is described a measure of, for example, approximating the refractive index of the substrate and the refractive index of the medium surrounding the metal nanostructures to each other in order to solve such a problem. In paragraph 0047 of JP-A-2009-085724, there is provided a description that the plasmon resonance conditions in the interface between the substrate and the metal structures are approximated to each other due to such a measure, and thus the peak width of the absorption spectrum can be narrowed. Further, in paragraph 0031 of JP-A-2009-085724, there is a description that if the shorter distance is enlarged, the enhancement degree of the electric field is decreased, and it is suggested that the localized plasmon is used in the device described in JP-A-2009-085724.

However, the structure disclosed in OPTICS TELLERS described above has the hotspot (HS) of the surface plasmon extremely localized and no larger than several nanometers, and cannot necessarily be said to be suitable for the inspection of a sample having a size equal to or larger than 5 nm such as a virus. Specifically, adopting a hybrid configuration to the GSPP model raises at least the following problems.

1. Since the arrangement pitch in the array of the metal particles (the gold particles) is 780 nm, which is roughly equal to the excitation wavelength (a condition for generating the PSP), although the enhancement degree in the hotspot can be increased, it is difficult to increase the hotspot density.

2. Since the position where the hotspot is formed becomes near the contact point between the metal particle (the gold particle) and SiO₂ as a foundation, the area becomes narrow so as to be difficult for the substance (the molecule) as the object of sensing to enter (to approach).

3. A manufacturing process for forming the sensor structure becomes complicated.

Further, in the technology disclosed in OPTICS EXPRESS, since the nanoparticles are formed using evaporation, the nano-gap is difficult to control, and it is also reported that the homogeneity of the SERS enhancement due to the variation becomes a value as large as 22.4%. Further, since the nano-gap is no larger than 5 nm, in the case in which the size of the sensing substance (the substance to be the measurement object) is larger than 5 nm in diameter, the sensing substance cannot enter the hotspot generated in the nano-gap similarly to the structure in OPTICS TELLERS. Therefore, there is a problem that it is unachievable to sufficiently enhance the SERS effect.

Further, in the target substance detection device of the JP-A-2009-085724 described above, the metal structures are directly arranged on the substrate in a reticular pattern, and polarized light is used that is obtained by swinging the electric field in a direction along which the arrangement is dense. Therefore, the diffraction grating obtained by arranging such metal structures in a line uses a function of Wood's anomalies. Therefore, the phenomenon is explained using the intensity of the transmitted light passing through slits constituted by the localized surface plasmons and the metal structures and the existent probability of the metal structures. Further, in such a device, since a metal layer or the like does not exist in the foundation of the metal structures, and the propagating surface plasmon is not used, no particularly strong enhancement effect can be expected, and it is difficult to be applied to SERS.

### SUMMARY

An advantage of some aspects of the invention is to provide an analysis device and an analysis method having the hotspots exposed on a surface of an optical element, and having a high plasmon enhancement effect, the optical element used for the analysis device and the analysis method, and an electronic apparatus.

Embodiments of the invention can be implemented as the following aspects or application examples.

An analysis device according to an aspect of the invention includes an optical element including a first metal layer, and second metal layers respectively disposed on dielectric columns penetrating the first metal layer and electrically insulated from the first metal layer, wherein the second metal layers are arranged in a first direction at a first pitch to constitute first metal rows, and the first metal rows are disposed so as to be arranged at a second pitch in a second direction intersecting with the first direction, a light source adapted to irradiate the optical element with incident light, and a detector adapted to detect light emitted from the optical element, and the arrangement of the second metal layers of the optical element satisfies a relationship of Formula 1 described below.

P1<P2≦Q+P1 (1)

where, P1 represents the first pitch, P2 represents the second pitch, Q represents a pitch of a diffraction grating provided by Formula 2 described below assuming that an angular frequency of a localized surface plasmon excited in the second metal layers is ω, a dielectric constant of metal constituting the first metal layer is ε(ω), a surrounding dielectric constant of the first metal layer is ε, a velocity of light in vacuum is c, and a tilt angle from a thickness direction of the first metal layer as an irradiation angle of the incident light is θ.

(ω/c)·{ε·ε(ω)/(ε+ε(ω))}^{1/2}=ε^{1/2}·(ω/c)·sin θ+2mπ/Q (m=±1, ±2, . . . ) (2)

According to such an analysis device, there is provided the optical element having a structure in which the end portions of the upper surface and the lower surface of the second metal layers are capable of having contact with the measurement object, and the hotspots are exposed on the element surfaces. Therefore, it is easy for the substance to be the analysis object to be located at the hotspot. Further, since the first metal layer is disposed in the vicinity of the second metal layers, the resonance effect of the localized surface plasmon and the propagating surface plasmon can be generated. Therefore, the enhancement degree of the light based on the plasmon is extremely high, and it is possible to analyze the substance to be the analysis object with extremely high sensitivity.

An analysis device according to an aspect of the invention includes an optical element including a first metal layer, and second metal layers respectively disposed on dielectric columns formed on the first metal layer and electrically insulated from the first metal layer, wherein the second metal layers are arranged in a first direction at a first pitch to constitute first metal rows, and the first metal rows are disposed so as to be arranged at a second pitch in a second direction intersecting with the first direction, a light source adapted to irradiate the optical element with incident light, and a detector adapted to detect light emitted from the optical element, and the arrangement of the second metal layers of the optical element satisfies a relationship of Formula 1 described below.

P1<P2≦Q+P1 (1)

where, P1 represents the first pitch, P2 represents the second pitch, Q represents a pitch of a diffraction grating provided by Formula 2 described below assuming that an angular frequency of a localized surface plasmon excited in the second metal layers is ω, a dielectric constant of metal constituting the first metal layer is ε(ω), a surrounding dielectric constant of the first metal layer is ε, a velocity of light in vacuum is c, and a tilt angle from a thickness direction of the first metal layer as an irradiation angle of the incident light is θ.

(ω/c)·{ε·ε(ω)/(ε+ε(ω))}^{1/2}=ε^{1/2}·(ω/c)·sin θ+2mπ/Q (m=±1, ±2, . . . ) (2)

According to such an analysis device, there is provided the optical element having a structure in which the end portions of the upper surface and the lower surface of the second metal layers are capable of having contact with the measurement object, and the hotspots are exposed on the element surfaces. Therefore, it is easy for the substance to be the analysis object to be located at the hotspot. Further, since the first metal layer is disposed in the vicinity of the second metal layers, the resonance effect of the localized surface plasmon and the propagating surface plasmon can be generated. Therefore, the enhancement degree of the light based on the plasmon is extremely high, and it is possible to analyze the substance to be the analysis object with extremely high sensitivity.

The analysis device according to the aspect of the invention may be configured such that the optical element includes a plurality of second metal rows each constituted by the second metal layers arranged in the first direction at a third pitch, and the second metal rows are disposed so as to be arranged in the second direction at the second pitch alternately with the first metal rows.

According to such an analysis device, the hotspot density can be raised.

The analysis device according to the aspect of the invention may be configured such that the first pitch and the third pitch are equal to each other, and the second metal layers belonging to the first metal rows and the second metal layers belonging to the second metal rows are the same in shape, dimensions, and height of location.

According to such an analysis device, it is possible to increase the freedom in adjusting the enhancement profile of the optical element in accordance with the wavelength of the scattering light depending on the substance to be the analysis object to thereby increase the hotspot density.

The analysis device according to the aspect of the invention may be configured such that the second metal layers belonging to the first metal rows and the second metal layers belonging to the second metal rows are different from each other in at least one of shape, dimensions, and height of location.

According to such an analysis device, it is possible to increase the freedom in adjusting the enhancement profile of the optical element in accordance with the wavelength of the scattering light depending on the substance to be the analysis object. Thus, a sufficiently high plasmon enhancement effect can be obtained with respect to a wide variety of analysis objects.

The analysis device according to the aspect of the invention may be configured such that the optical element includes a plurality of second metal rows each constituted by the second metal layers arranged in the first direction at a third pitch, and a plurality of third metal rows each constituted by the second metal layers arranged in the first direction at a fourth pitch, the second metal rows and the third metal rows are each disposed so as to be arranged in the second direction at the second pitch alternately with the first metal rows, and the second metal layers belonging respectively to the first metal rows, the second metal rows, and the third metal rows are different from each other in at least one of shape, dimensions, and height of location.

According to such an analysis device, it is possible to increase the freedom in adjusting the enhancement profile of the optical element in accordance with the wavelength of the scattering light depending on the substance to be the analysis object. Thus, a sufficiently high plasmon enhancement effect can be obtained with respect to a wide variety of analysis objects.

The analysis device according to the aspect of the invention may be configured such that the incident light is linearly-polarized light in a direction identical to the first direction.

The analysis device according to the aspect of the invention may be configured such that the incident light is linearly-polarized light in a direction identical to the second direction.

The analysis device according to the aspect of the invention may be configured such that the incident light is circularly-polarized light.

According to this analysis device, since the enhancement degree profile of the light based on the plasmon of the optical element can be set to be broad, the detection and the measurement of a wide variety of trace substances can easily be performed.

The analysis device according to the aspect of the invention may be configured such that the detector detects Raman scattering light enhanced by the optical element.

According to such an analysis device, since the optical element high in enhancement degree of the light based on the plasmon is provided, the Raman scattering light can sufficiently enhanced, and therefore, identification of the trace substance can easily be performed.

An optical element according to an aspect of the invention includes a first metal layer, and second metal layers respectively disposed on dielectric columns penetrating the first metal layer and electrically insulated from the first metal layer, wherein the second metal layers are arranged in a first direction at a first pitch to constitute first metal rows, and the first metal rows are disposed so as to be arranged at a second pitch in a second direction intersecting with the first direction, and the arrangement of the second metal layers satisfies a relationship of Formula 1 described below.

P1<P2≦Q+P1 (1)

where, P1 represents the first pitch, P2 represents the second pitch, Q represents a pitch of a diffraction grating provided by Formula 2 described below assuming that an angular frequency of a localized surface plasmon excited in the second metal layers is ω, a dielectric constant of metal constituting the first metal layer is ε(ω), a surrounding dielectric constant of the first metal layer is ε, a velocity of light in vacuum is c, and a tilt angle from a thickness direction of the first metal layer as an irradiation angle of the incident light is θ.

(ω/c)·{ε·ε(ω)/(ε+ε(ω))}^{1/2}=ε^{1/2}·(ω/c)·sin θ+2mπ/Q (m=±1, ±2, . . . ) (2)

According to such an optical element, there is provided a structure in which the end portions of the upper surface and the lower surface of the second metal layers are capable of having contact with the measurement object, and the hotspots are exposed on the element surfaces. Therefore, it is easy for the substance to be the analysis object to be located at the hotspot. Further, since the first metal layer is disposed in the vicinity of the second metal layers, the resonance effect of the localized surface plasmon and the propagating surface plasmon can be generated. Therefore, it is possible to obtain the high enhancement degree of the light based on the plasmon.

An analysis method according to an aspect of the invention includes: irradiating an optical element with incident light, detecting light emitted from the optical element in accordance with the irradiation with the incident light, and analyzing an object attached to a surface of the optical element, the optical element includes a first metal layer, and second metal layers respectively disposed on dielectric columns penetrating the first metal layer and electrically insulated from the first metal layer, wherein the second metal layers are arranged in a first direction at a first pitch to constitute first metal rows, and the first metal rows are disposed so as to be arranged at a second pitch in a second direction intersecting with the first direction, and the second metal layers of the optical element are arranged so as to satisfy a relationship of Formula 1 described below.

P1<P2≦Q+P1 (1)

where, P1 represents the first pitch, P2 represents the second pitch, Q represents a pitch of a diffraction grating provided by Formula 2 described below assuming that an angular frequency of a localized surface plasmon excited in the second metal layers is ω, a dielectric constant of metal constituting the first metal layer is ε(ω), a surrounding dielectric constant of the first metal layer is ε, a velocity of light in vacuum is c, and a tilt angle from a thickness direction of the first metal layer as an irradiation angle of the incident light is θ.

(ω/c)·{ε·ε(ω)/(ε+ε(ω))}^{1/2}=ε^{1/2}·(ω/c)·sin θ+2mπ/Q (m=±1, ±2, . . . ) (2)

According to such an analysis method, since the optical element high in enhancement degree based on the plasmon is used, detection and measurement of the trace substance can easily be performed, and the substance to be the analysis object can be analyzed with extremely high sensitivity.

An analysis method according to an aspect of the invention includes: irradiating an optical element with incident light, detecting light emitted from the optical element in accordance with the irradiation with the incident light, and analyzing an object attached to a surface of the optical element, the optical element includes a first metal layer, and second metal layers respectively disposed on dielectric columns formed on the first metal layer and electrically insulated from the first metal layer, wherein the second metal layers are arranged in a first direction at a first pitch to constitute first metal rows, and the first metal rows are disposed so as to be arranged at a second pitch in a second direction intersecting with the first direction, and the second metal layers of the optical element are arranged so as to satisfy a relationship of Formula 1 described below.

P1<P2≦Q+P1 (1)

where, P1 represents the first pitch, P2 represents the second pitch, Q represents a pitch of a diffraction grating provided by Formula 2 described below assuming that an angular frequency of a localized surface plasmon excited in the second metal layers is ω, a dielectric constant of metal constituting the first metal layer is ε(ω), a surrounding dielectric constant of the first metal layer is ε, a velocity of light in vacuum is c, and a tilt angle from a thickness direction of the first metal layer as an irradiation angle of the incident light is θ.

(ω/c)·{ε·ε(ω)/(ε+ε(ω))}^{1/2}=ε^{1/2}·(ω/c)·sin θ+2mπ/Q (m=±1, ±2, . . . ) (2)

According to such an analysis method, since the optical element high in enhancement degree based on the plasmon is used, detection and measurement of the trace substance can easily be performed, and the substance to be the analysis object can be analyzed with extremely high sensitivity.

An electronic apparatus according to an aspect of the invention includes the analysis device according to the aspect of the invention described above, an operation section adapted to perform an operation on health medical information based on detection information from the detector, a storage section adapted to store the health medical information, and a display section adapted to display the health medical information.

According to such an electronic apparatus, since the optical element high in enhancement degree of the light based on the plasmon is provided, detection of the trace substance can easily be performed, and thus, highly accurate health medical information can be provided.

The electronic apparatus according to the aspect of the invention may be configured such that the health medical information includes information related to one of presence or absence and an amount of one of at least one biologically-relevant substance selected from a group consisting of bacteria, a virus, a protein, a nucleic acid, and an antigen/antibody, and at least one compound selected from an inorganic molecule and an organic molecule.

According to such an electronic apparatus, helpful health medical information can be provided.

### BRIEF DESCRIPTION OF THE DRAWINGS

FIG. 1 is a perspective view schematically showing an optical element according to an embodiment of the invention.

FIG. 2 is a schematic view of the optical element according to the embodiment viewed from a thickness direction of a first metal layer.

FIG. 3 is a schematic view of a cross-section perpendicular to the first direction of the optical element according to the embodiment.

FIG. 4 is a schematic view of a cross-section perpendicular to the second direction of the optical element according to the embodiment.

FIG. 5 is a schematic view of the optical element according to the embodiment viewed from the thickness direction of the first metal layer.

FIG. 6 is a graph of a dispersion relationship showing dispersion curves of incident light, gold, and silver.

FIG. 7 is a graph showing a relationship between the dielectric constant of Ag and the wavelength.

FIG. 8 is a graph showing dispersion curves of metals and a dispersion relationship between the localized plasmon and the incident light.

FIGS. 9A and 9B are schematic diagrams each showing a part of the optical element according to the embodiment in comparison with a GSPP model.

FIG. 10 is a planar schematic view showing an example of second metal rows.

FIG. 11 is a planar schematic view showing an example of the second metal rows.

FIG. 12 is a schematic diagram of an analysis device according to the embodiment.

FIG. 13 is a schematic diagram of an electronic apparatus according to the embodiment.

FIGS. 14A-C are schematic diagrams showing an example of a model according to an experimental example.

FIGS. 15A-D are schematic diagrams and graphs showing models according to the experimental example and the reflectance characteristics.

FIGS. 16A-B are a pair of graphs showing the reflectance characteristics and enhancement degree profiles of the models according to the experimental example.

FIG. 17 is a graph showing the reflectance characteristics of the models according to the experimental example.

FIGS. 18A-D are a set of diagrams showing distributions of hotspots of the models according to the experimental example.

FIGS. 19A-D are a set of diagrams showing distributions of hotspots of the models according to the experimental example.

FIGS. 20A-B are a pair of diagrams schematically showing the models according to the experimental example.

FIGS. 21A-B are a pair of diagrams schematically showing the models according to the experimental example.

FIGS. 22A-B are a pair of graphs showing positional dependencies of the hotspots of the models according to the experimental example.

FIGS. 23A-B are a set of diagrams schematically showing the models according to the experimental example.

FIGS. 24A-B are a pair of graphs showing the reflectance characteristics and enhancement degree profiles of models according to an experimental example.

FIG. 25 is a graph showing normalized reflectance characteristics of models according to an experimental example.

FIGS. 26A-B are a graph and a table of a dispersion relationship according to the experimental example.

FIGS. 27A-B are a pair of graphs showing an enhancement degree profile and an enhancement degree of the Raman scattering of the models according to the experimental example.

FIGS. 28A-B are a graph and a table of a dispersion relationship according to the experimental example.

FIGS. 29A-C are a set of graphs showing reflectance characteristics of models according to an experimental example.

FIGS. 30A-B is a graph and a table of a dispersion relationship according to the experimental example.

FIGS. 31A-B are schematic diagrams showing an example of a model according to an experimental example.

FIG. 32 is a graph showing reflectance characteristics of the models according to the experimental example.

FIGS. 33A through 33C are schematic diagrams showing examples of the model according to the experimental example.

FIG. 34 is a graph showing reflectance characteristics of the models according to the experimental example.

FIGS. 35A-B are a set of schematic diagrams showing an example of models according to an experimental example.

FIGS. 36A-B are a pair of graphs showing reflectance characteristics of the models according to the experimental example.

FIGS. 37A-B are a pair of graphs showing the reflectance characteristics and enhancement degree profiles of the models according to the experimental example.

FIGS. 38A-B are a pair of schematic diagrams showing an example of models according to an experimental example.

FIG. 39 is a graph showing reflectance characteristics of the models according to the experimental example.

### DESCRIPTION OF EXEMPLARY EMBODIMENTS

Hereinafter, some embodiments of the invention will be explained. The embodiments explained hereinafter are each for explaining an example of the invention. The invention is not at all limited by the embodiments described below, and includes a variety of types of modified configurations to be put into practice within the scope or the spirit of the invention. It should be noted that all of the constituents explained hereinafter are not necessarily essential elements of the invention.

### 1. OPTICAL ELEMENT

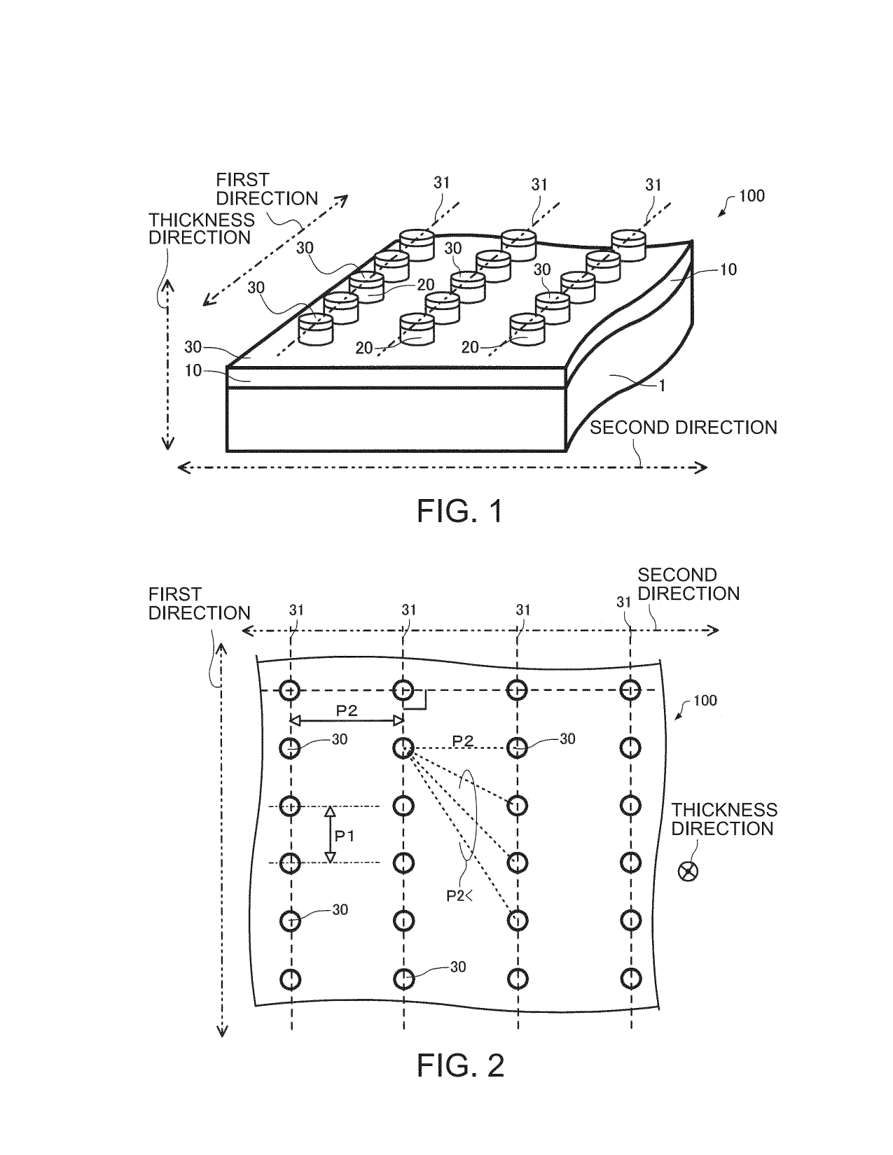

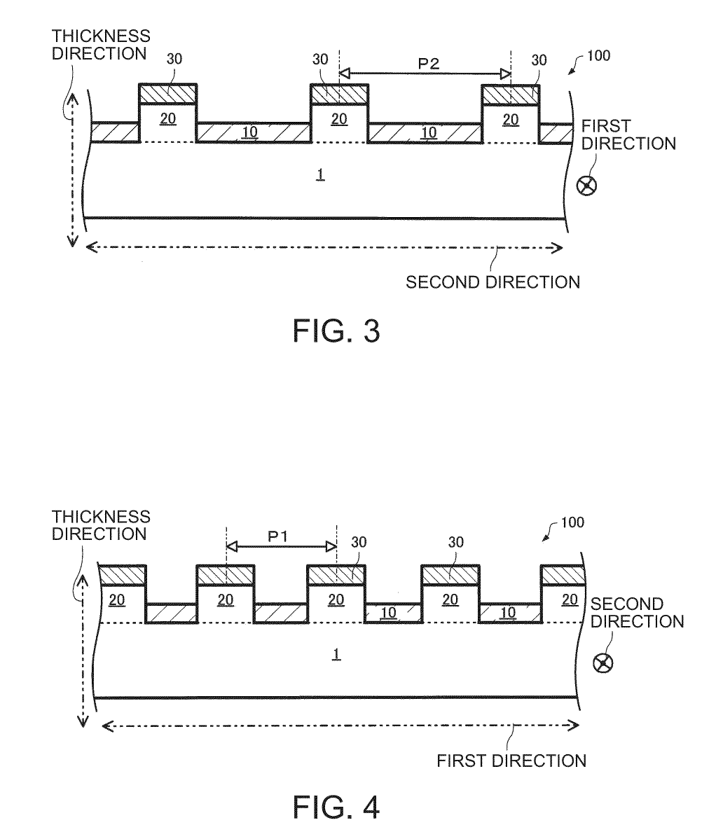

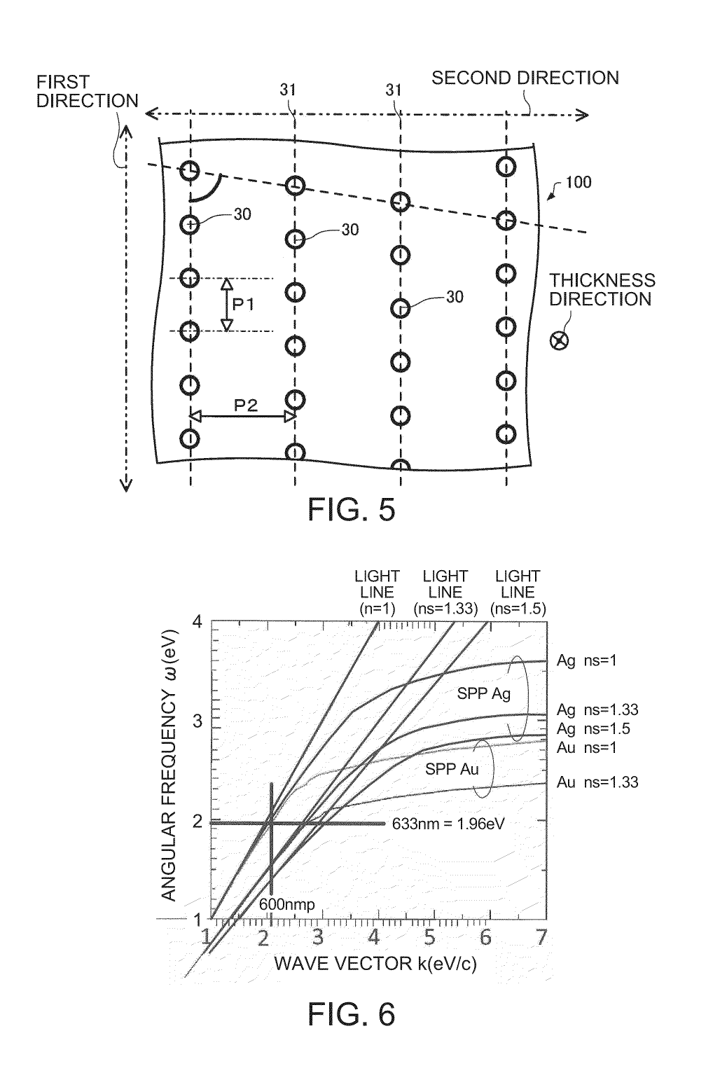

FIG. 1 is a perspective view of an optical element 100 according to the present embodiment. FIG. 2 is a schematic view of the optical element 100 according to the present embodiment viewed in a planar manner (viewed from the thickness direction of a first metal layer 10). FIGS. 3 and 4 are each a schematic diagram of a cross-section of the optical element 100 according to the present embodiment. FIG. 5 is a schematic view of an example of another configuration of the optical element 100 according to the present embodiment viewed from the thickness direction of the first metal layer 10. The optical element 100 according to the present embodiment includes the first metal layer 10, and second metal layers 30 disposed on dielectric columns 20 formed so as to penetrate the surface of the first metal layer 10.

### 1.1. First Metal Layer

The first metal layer 10 is not particularly limited providing a light-blocking metal surface is provided, and can have a shape of a film, a layer, or a membrane. The first metal layer 10 can also be disposed on, for example, a substrate 1. The substrate 1 on this occasion is not particularly limited, but one that does not affect a propagating surface plasmon to be excited in the first metal layer 10 is preferable. As the substrate 1, there can be cited, for example, a glass substrate, a silicon substrate, and a resin substrate. The shape of the surface of the substrate 1 on which the first metal layer 10 is disposed is not particularly limited. In the case of forming a regular structure on the surface of the first metal layer 10, it is possible to provide a surface corresponding to the regular structure. Further, in the case of making the surface of the first metal layer 10 flat, it is possible to make the surface of the corresponding part flat. In the example shown in FIGS. 1 through 5, the first metal layer 10 is disposed on the surface (flat) of the substrate 1.

Here, although the expression of flat is used, the expression does not denote that the surface is a smooth, mathematically-rigid flat surface without minor unevenness. For example, unevenness due to the constituent atoms and unevenness due to secondary structures (e.g., crystals, grain aggregates, and grain boundaries) of the constituent substance exist on the surface in some cases, and there is a case in which the surface is not a precisely flat surface in the microscopic sense. However, even in such a case, from a more macroscopic viewpoint, such unevenness becomes less prominent, and is observed to be in a level having no difficulty in calling the surface a flat surface. Therefore, in the present specification, it is assumed that if the surface can be recognized as a flat surface in the case of observing the surface from such a macroscopic viewpoint, the surface is referred to as a flat surface.

Further, in the present embodiment, the thickness direction of the first metal layer 10 can coincide with the thickness direction of the second metal layers 30 described later. In the present specification, in some cases, the thickness direction of the first metal layer 10 is referred to as a thickness direction, a height direction, and so on in the case of describing the dielectric columns 20 and the second metal layer 30 described later. Further, in the case in which, for example, the first metal layer 10 is disposed on the surface of the substrate 1, the normal direction of the surface of the substrate 1 is referred to as a thickness direction or a height direction in some cases. Further, in some cases, a direction on the first metal layer 10 side viewed from the substrate 1 is expressed as an upper or an upside, and the opposite direction is expressed as a lower or a downside.

At least the surface of the first metal layer 10 is penetrated by the dielectric columns 20 described later. The expression that the surface is penetrated includes the case in which the first metal layer 10 is thin, and the first metal layer 10 is penetrated by the dielectric columns 20, and the case in which the first metal layer 10 is thick, and the lower part of each of the dielectric columns 20 is embedded in the surface side of the first metal layer 10.

The first metal layer 10 can be formed by a process such as a vapor deposition process, a sputtering process, a casting process, or a machining process. Further, the first metal layer 10 can also be formed in the same process as the second metal layer 30 described later. In the case in which the first metal layer 10 is disposed on the substrate 1 as a thin film, it is also possible to dispose the first metal layer on the entire surface of the substrate 1 except the dielectric columns 20, or on a part of the substrate 1. The thickness of the first metal layer 10 is not particularly limited as long as the propagating surface plasmon is excited in the first metal layer 10, and can be set to be, for example, no smaller than 10 nm and no larger than 1 mm, preferably no smaller than 20 nm and no larger than 100 μm, and more preferably no smaller than 30 nm and no larger than 1 μm.

The first metal layer 10 is formed of metal in which there can exist an electric field provided by the incident light and vibrating in an opposite phase to the phase of the vibration of the polarization excited by the electric field, namely the metal in which the real part of the dielectric function can have a negative value (a negative dielectric constant) and the dielectric constant in the imaginary part can be smaller than an absolute value of the dielectric constant in the real part in the case in which a specific electric field is applied. As an example of the metal capable of having such a dielectric constant in the visible range, there can be cited silver, gold, aluminum, copper, platinum, alloys of any of these metals, and so on. Further, the surface (the end surface in the thickness direction) of the first metal layer 10 can, but is not required to, be a specific crystal plane.

The first metal layer 10 has a function of generating the propagating surface plasmon in the optical element 100 according to the present embodiment. By making the light enter the first metal layer 10 in the condition described later, the propagating surface plasmon occurs in the vicinity of the surface (the end surface in the thickness direction) of the first metal layer 10. Further, in the present specification, a quantum of the vibration formed of the vibration of the charges in the vicinity of the surface of the first metal layer 10 and the electromagnetic wave combined with each other is referred to as a surface plasmon polariton (SPP) in some cases. The propagating surface plasmon generated in the first metal layer 10 can interact (hybrid) with the localized surface plasmon generated in the second metal layers 30 described later under certain conditions.

### 1.2. Dielectric Column

The dielectric columns 20 are each disposed so as to penetrate the surface of the first metal layer 10. Then, the second metal layers 30 are disposed on the respective dielectric columns 20. Therefore, it results that the first metal layer 10 and the second metal layers 30 are disposed spatially separated from each other.

The shape of each of the dielectric columns 20 is not particularly limited provided that the dielectric column 20 is projected from the upper surface of the first metal layer 10, and the second metal layer 30 can be disposed on the dielectric column 20. As the shape of the dielectric column 20, there can be cited, for example, a columnar shape, a frustum shape, an inverted frustum shape, and a bump shape. The shape (the contour shape) of the cross-section of the dielectric column 20 cut by a plane parallel to the surface of the substrate 1 can be set to a circle, an ellipse, a polygon, or a shape obtained by combining these shapes, and the shape and the size (dimension) of such a cross-section can also be changed depending on the position of the cross-section from the surface of the substrate 1.

The dielectric columns 20 can be formed integrally with the substrate 1 in the case in which the first metal layer 10 is a thin film. In the example shown in FIGS. 1 through 5, the dielectric columns 20 are is formed integrally with the substrate 1. Further, in the case in which the thickness of the first metal layer 10 is large, the dielectric columns 20 can also be embedded in holes formed in the upper surface of the first metal layer 10. The material of the dielectric columns 20 can be the same as that of the substrate 1, or can also be different from that of the substrate 1.

The dielectric columns 20 can also be formed when forming, for example, the substrate 1. Further, the dielectric columns 20 can also be formed using, for example, a method of combining a vapor deposition process, a sputtering process, a CVD process, and a variety of coating process, and a photolithography method, a microcontact printing method, or a nanoimprint method. Further, through holes or blind holes are formed in the first metal layer 10 using a photolithography process or the like after forming the first metal layer 10, and then the dielectric columns 20 can also be formed so as to be embedded into the holes. The dielectric columns 20 can also be formed before forming the first metal layer 10. In the case in which the dielectric columns 20 are formed before forming the first metal layer 10, the first metal layer 10 and the second metal layer 30 can be formed in a single process in some cases, and thus, the manufacturing of the optical element 100 can efficiently be performed in some cases.

The height (a distance from a position of a “bottom surface” of the first metal layer 10 to a position of a lower surface of the second metal layers 30 along the thickness direction of the first metal layer 10) of the dielectric columns 20 is not particularly limited as long as the propagating surface plasmon of the first metal layer 10 and the localized surface plasmon of the second metal layer can interact with each other.

The height of the dielectric columns 20 can also be set to a height with which a high-order interference effect can be used. The height of the dielectric columns 20 can be set to be, for example, no smaller than 1 nm and no larger than 1 μm, preferably no smaller than 5 nm and no larger than 500 nm, more preferably no smaller than 10 nm and no larger than 100 nm, further preferably no smaller than 15 nm and no larger than 80 nm, and particularly preferably no smaller than 20 nm and no larger than 60 nm, and is set so that the interaction and the interference effect described above can be obtained.

It should be noted that in the present specification, the distance from the position of the “upper surface” of the first metal layer 10 to the position of the lower surface of the second metal layer 30 in the thickness direction of the first metal layer 10 is referred to as a “gap” in some cases, and is indicated by “G” in the drawing and so on in some cases.

The planar size (dimension) (the size in a direction perpendicular to the height direction of the dielectric columns 20) of the dielectric columns 20 means the length of a zone in a specific direction where the dielectric columns 20 can be cut by a plane parallel to the height direction of the dielectric columns 20, and is, for example, no smaller than 5 nm and no larger than 200 nm. In the case in which, for example, the shape of the dielectric column 20 is a cylinder having a center axis in the height direction, the size (the diameter of the cylinder) of the dielectric column 20 is no smaller than 10 nm and no larger than 200 nm, preferably no smaller than 20 nm and no larger than 150 nm, more preferably no smaller than 25 nm and no larger than 100 nm, and further preferably no smaller than 30 nm and no larger than 72 nm. Further, the planar size (dimension) of the upper surface of the dielectric column 20 can be larger than the planar size of the second metal layer 30 described later.

It should be noted that in the present specification, in the case in which the shape of the dielectric column 20 is the cylinder having the center axis in the height direction, the diameter of the dielectric column 20 is denoted as “D” in the drawings and so on in some cases.

The dielectric columns 20 are only required to have a positive dielectric constant, and can be formed of, for example, SiO₂, Al₂O₃, TiO₂, a polymer (resin), indium tin oxide (ITO), or a complex of these materials. Further, the dielectric columns 20 can be formed including a dielectric body, or not required to include the dielectric body, and is assumed to be referred to as the dielectric columns 20 in both of the cases. Further, the dielectric columns 20 can each be composed of a plurality of parts (e.g., a laminate structure) different in material from each other.

The excitation peak frequency of the localized surface plasmon generated in the second metal layers 30 is shifted in some cases depending on the size or the height of the dielectric columns 20, which should be taken into consideration in some cases when obtaining the peak excitation wavelength of the localized surface plasmon in the setting of a pitch P2 described later.

### 1.3. Second Metal Layer

The second metal layers 30 are disposed so as to be separated from the first metal layer 10 in the thickness direction. It is sufficient for the second metal layers 30 to be disposed so as to spatially be separated from the first metal layer 10. In the example shown in FIGS. 1 through 5 of the present embodiment, since the second metal layers 30 are formed on the dielectric columns 20 penetrating the first metal layer 10, the first metal layer 10 and the second metal layers 30 are disposed so as to spatially be separated from each other in the height direction of the dielectric columns 20.

The shape of second metal layer 30 is not particularly limited. For example, the shape of the second metal layer 30 can be a circle, an ellipse, a polygon, an infinite form, or a shape obtained by combining these shapes in the case (in the planar view viewed from the thickness direction) of being projected in the thickness direction of the first metal layer 10. Further, the shape of the second metal layer 30 can have an overlap with the first metal layer 10, but does not need to have the overlap in the case (in the planar view viewed from the thickness direction) of being projected in the thickness direction of the first metal layer 10.

The shape of the second metal layer 30 can be a circle, an ellipse, a polygon, an infinite form, or a shape obtained by combining these shapes although a part to be a shape along the upper surface of the dielectric column 20 in the case (in the case of a side view) of being projected in a direction perpendicular to the thickness direction of the first metal layer 10. In the example shown in FIGS. 1 through 5, a cylindrical shape (a disk-like shape) having the center axis in the thickness direction of the first metal layer 10 is shown as an example of the second metal layers 30, and the shape is rectangular in the side view.

The size T (the thickness T in the case of the thin film shape) in the height direction of the second metal layers 30 means the length of the zone in the height direction where the second metal layers 30 can be cut by a plane perpendicular to the height direction, and is no smaller than 10 nm and no larger than 1 mm, preferably no smaller than 20 nm and no larger than 100 μm, and more preferably no smaller than 30 nm and no larger than 1 μm. The size (the thickness) in the height direction of the second metal layers 30 can be the same as, or different from the thickness of the first metal layer 10.

Further, the size in the direction perpendicular to the height direction of the second metal layer 30 means the length of the zone in a specific direction where the second metal layer 30 can be cut by a plane parallel to the height direction, and is no smaller than 5 nm and no larger than 200 nm. In the case in which, for example, the shape of the second metal layer 30 is a disk-like shape having a center axis in the height direction, the size (the diameter of the disk) in the first direction of the second metal layer 30 is no smaller than 10 nm and no larger than 200 nm, preferably no smaller than 20 nm and no larger than 150 nm, more preferably no smaller than 25 nm and no larger than 100 nm, and further preferably no smaller than 30 nm and no larger than 72 nm.

It should be noted that in the present specification, in the case in which the shape of the second metal layer 30 is the disk-like shape having the center axis in the height direction, the diameter of the second metal layer 30 is denoted as “D” in the drawings and so on in some cases.

The shape and the material of the second metal layer 30 are arbitrary as long as the localized surface plasmon can be generated in response to the irradiation with the incident light. As an example of the material capable of generating the localized surface plasmon due to the light in the vicinity of the visible range, there can be cited silver, gold, aluminum, copper, platinum, alloys of any of these metals, and so on.

The second metal layers 30 can be formed using, for example, a sputtering process or a vapor deposition process (including a tilted configuration if desired), and can also be formed using a method of further performing patterning subsequently to such processes if desired, a microcontact printing method, a nanoimprint method, and so on. Further, the second metal layers 30 can also be formed using a colloid chemical method, and it is also possible to arrange colloid fine particles on the dielectric columns 20 using an arbitrary method.

The second metal layers 30 have a function of generating the localized surface plasmon in the optical element 100 according to the present embodiment. By irradiating the second metal layers 30 with the incident light as described later, the localized surface plasmon can be generated in the periphery of each of the second metal layers 30. The localized surface plasmon generated in the second metal layers 30 can interact (hybrid) with the propagating surface plasmon generated in the first metal layer 10 described above under the certain conditions.

### 1.4. Arrangement of Second Metal Layers

As shown in FIGS. 1 through 5, the plurality of second metal layers 30 is arranged together with the dielectric columns 20 in the first direction at a first pitch P1 to constitute first metal rows 31. Further, the plurality of first metal rows 31 is arranged side by side in the second direction intersecting with the first direction at a second pitch P2. It should be noted that regarding a pattern of the arrangement in the first direction, it is sufficient for the second metal layers 30 to be disposed continuously along the first direction, and it is also possible for the second metal layers 30 adjacent to each other to be shifted in the second direction to some extent as long as the first metal row 31 can be identified such as a zigzag alignment. In the example shown in the drawings, the second metal layers 30 in the first metal row 31 are linearly arranged in the first direction.

In the first metal row 31, the second metal layers are arranged side by side in the first direction perpendicular to the thickness direction of the first metal layer 10. Therefore, the dielectric columns 20 are arranged side by side in the first direction perpendicular to the thickness direction of the first metal layer 10, and the plurality of second metal layers 30 disposed thereon is arranged in the first direction perpendicular to the height direction to constitute the first metal row 31. In the case in which the second metal layers 30 each have a shape having a longitudinal in a planar view (the case of a shape having an anisotropy), the first direction along which the second metal layers 30 are arranged is not necessarily required to coincide with the longitudinal direction of the second metal layer 30. The number of the second metal layers 30 arranged in each of the first metal rows 31 is only required to be plural, and is preferably equal to or larger than ten. Further, at least one of the size (dimension), the shape, and the height (gap) of the location can be equal, or can be different between the second metal layers 30 belonging to the first metal row 31 provided that the peak wavelengths of the localized surface plasmons generated in the respective second metal layers 30 roughly coincide with each other.

Here, the distance between the centroids in the planar view of the second metal layers 30 in the first direction in the first metal row 31 is defined as the pitch P1 (see FIGS. 2, 4, and 5). Further, in the case in which the second metal layers 30 each have the disk-like shape having the center axis in the thickness direction of the first metal layer 10, the distance between the two second metal layers 30 in the first metal row 31 is equal to the length obtained by subtracting the diameter of the disk from the pitch P1. If the distance decreases, the effect of the localized surface plasmon acting between the particles increases, and the enhancement degree can be increased in some cases. The distance between the second metal layers 30 in the first direction can be set to be no smaller than 5 nm and no larger than 1 μm, preferably no smaller than 5 nm and no larger than 100 nm, and more preferably no smaller than 5 nm and no larger than 30 nm.

The pitch P1 of the second metal layers 30 in the first direction in the first metal row 31 is no smaller than 10 nm and no larger than 1 μm, and can preferably be set to be no smaller than 20 nm and no larger than 800 nm, more preferably no smaller than 30 nm and no larger than 780 nm, and further preferably no smaller than 50 nm and no larger than 700 nm.

Although the first metal row 31 is formed of the plurality of second metal layers 30 arranged in the first direction at the pitch P1, the distribution, intensity, and so on of the localized surface plasmons generated in the second metal layers 30 of the first metal row 31 also depend on the arrangement of the second metal layers 30. Therefore, the localized surface plasmons interacting with the propagating surface plasmons generated in the first metal layer 10 are not limited to the localized surface plasmons generated in the unit second metal layer 30, but are the localized surface plasmons taking the arrangement of the second metal layers 30 in the first metal row 31 into consideration.

As shown in FIGS. 1 through 5, the first metal rows are arranged side by side in the second direction intersecting with the thickness direction of the first metal layer 10 and the first direction at the pitch P2. The number of the first metal rows 31 thus arranged is only required to be plural, and is preferably equal to or larger than ten.

Here, the distance between the centroids in the second direction of the first metal rows 31 adjacent to each other is defined as the pitch P2 (see FIGS. 2, 3, 5, and so on). The pitch P2 between the first metal rows 31 is set conforming to the conditions described in “1.4.1. Propagating Surface Plasmon and Localized Surface Plasmon” below, and is, for example, no smaller than 10 nm and no larger than 10 μm, and can preferably be set to be no smaller than 20 nm and no larger than 2 μm, more preferably no smaller than 30 nm and no larger than 1500 nm, further preferably no smaller than 60 nm and no larger than 1310 nm, and particularly preferably no smaller than 60 nm and no larger than 660 nm.

It should be noted that an angle formed between a line along the first direction in which the first metal rows 31 extend and a line connecting the two second metal layers 30, which belong respectively to the first metal rows 31 adjacent to each other and are the closest to each other, is not particularly limited, and can, but is not required to, be a right angle. For example, the angle formed between both lines can be a right angle as shown in FIG. 2, or the angle formed between both lines can be a non-right angle as shown in FIG. 5. In other words, in the case in which it is assumed that the arrangement of the second metal layers 30 viewed from the thickness direction is a two-dimensional lattice taking the positions of the second metal layers 30 as the lattice points, an irreducible basic unit lattice can have a rectangular shape or a parallelogram shape. Further, in the case in which the angle formed between the line along the first direction in which the first metal rows 31 extend and the line connecting the two second metal layers 30, which belong respectively to the first metal rows 31 adjacent to each other and are the closest to each other, is a non-right angle, a pitch between the two second metal layers 30, which belong respectively to the first metal rows 31 adjacent to each other and are the closest to each other, can be set as the pitch P2.

### 1.4.1. Propagating Surface Plasmon and Localized Surface Plasmon

Firstly, the propagating surface plasmon will be explained. FIG. 6 is a graph of a dispersion relationship showing dispersion curves of the incident light, silver, and gold. Normally, even when the light enters the first metal layer 10 with an incident angle (an irradiation angle θ) in a range of 0 through 90 degree, the propagating surface plasmon is not generated. This is because in the case in which, for example, the first metal layer 10 is made of Ag, the light line and the dispersion curve of the SPP of Ag do not have an intersection (in the case in which the peripheral refractive indexes are the same) as shown in FIG. 6. Further, even if the refractive index of the medium through which the light is transmitted varies, since the SPP of Ag also varies with the surrounding refractive index, it results that no intersection is provided. In order to provide the intersection to generate the propagating surface plasmon, there can be cited a method of providing a metal layer on a prism in such a manner as a Kretschmann configuration to increase the wave number of the incident light due to the refractive index of the prism, and a method of increasing the wave number of the light line using a diffraction grating. It should be noted that FIG. 6 is a graph (having the vertical axis representing angular frequency [ω(eV)], and the horizontal axis representing wave vector [k(eV/c)]) showing the dispersion relationship.

Further, the angular frequency ω(eV) represented by the vertical axis of the graph of FIG. 6 has a relationship of λ(nm)=1240/ω(eV), and can be converted into the wavelength. Further, the wave vector k (eV/c) represented by the horizontal axis of the graph has the following relationship.

k(eV/c)=2π·2/{λ(nm)/100}

Therefore, in the case of, for example, λ=600 nm, k=2.09 (eV/c) is obtained. Further, the irradiation angle is the irradiation angle of the incident light, and corresponds to a tilted angle from the thickness direction of the first metal layer 10 or the height direction of the second metal layers 30.

Although FIG. 6 shows the dispersion curves of the SPP of Ag and Au, in general, the dispersion curve is provided by Formula 3 assuming that the angular frequency of the incident light input to the first metal layer 10 is ω, a velocity of light in vacuum is c, the dielectric constant of the metal constituting the first metal layer 10 is ε(ω), and the surrounding dielectric constant is ε.

K_{SPP}=ω/c{ε·ε(ω)/(ε+ε(ω))}^{1/2} (3)

Meanwhile, assuming the irradiation angle of the incident light, namely the tilted angle from the thickness direction of the first metal layer 10 or the height direction of the second metal layer 30, is θ, the wave number K of the incident light having passed through a virtual diffraction grating with the pitch Q can be expressed as Formula 4, and the relationship appears on the graph as a straight line instead of a curve.

K=n·(ω/c)·sin θ+m·2π/Q (m=±1, ±2, . . . ) (4)

It should be noted that n represents the surrounding refractive index, if the extinction coefficient is assumed to be κ, the real part ε′ and the imaginary part ε″ of the relative permittivity ε at the frequency of the light are respectively obtained as ε′=n²−κ², ε″=2nκ, and if the surrounding substance is transparent, κ≈0 is true, and therefore, ε is a real number, and ε=n² is obtained, and therefore, n=ε^{1/2} is obtained.

The propagating surface plasmon is excited in the case in which the dispersion curve (Formula 3 described above) of the SPP of the metal and the straight line (Formula 4 described above) of the diffracted light have an intersection with each other in the graph of the dispersion relationship. In other words, if the relationship of K_{SPP}=K becomes true, the propagating surface plasmon is excited in the first metal layer 10.

Therefore, Formula 2 below can be obtained from Formula 3 and Formula 4 described above, and it is understood that if the relationship of Formula 2 is satisfied, the propagating surface plasmon is excited in the first metal layer 10.

(ω/c)·{ε·ε(ω)/(ε+ε(ω))}^{1/2}=ε^{1/2}·(ω/c)·sin θ+2mπ/Q (m=±1, ±2, . . . ) (2)

In this case, referring to the example of the SPP of Ag shown in FIG. 6, by varying θ and m, the gradient, the intercept, or the gradient and the intercept of the light line can be changed, and it is possible to make the straight line of the light line intersect with the dispersion curve of the SPP of Ag.

Then, the localized surface plasmon will be explained. The condition for generating the localized surface plasmon in the second metal layers 30 can be obtained by the real part of the dielectric constant as Formula 5 below.

Real[ε(ω)]=−2ε (5)

Assuming the surrounding refractive index n is 1, since ε=n²−κ²=1 is true, Real[ε(ω)]=−2 is obtained.

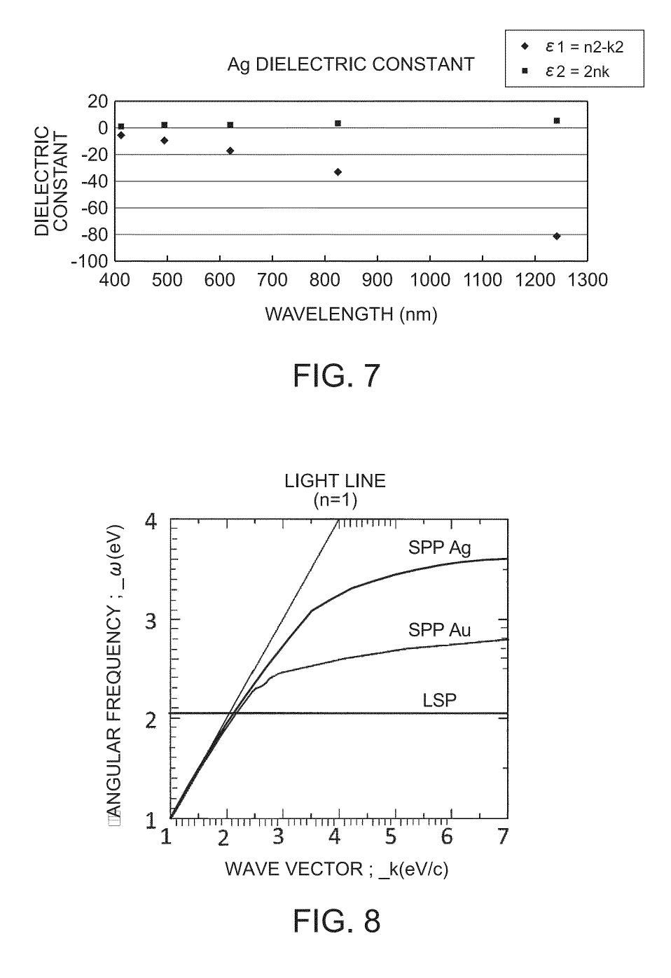

FIG. 7 is a graph showing a relationship between the dielectric constant of Ag and the wavelength as an example. For example, the dielectric constant of Ag is as shown in FIG. 7, and it results that the localized surface plasmon is excited at the wavelength equal to or longer than about 400 nm. However, in the case in which a plurality of Ag structures approach to each other in the order of several nanometers, or the case in which the Ag structure and the first metal layer 10 (e.g., an Ag film) are disposed so as to be separated with the dielectric column 20 (e.g., SiO₂), a red shift (a shift toward the long wavelength side) occurs in the excitation peak wavelength of the localized surface plasmon due to the influence of the gap. Although the shift amount depends on the dimensions such as the size, the thickness, the distance, and the pitch of the Ag structures, and the height (the gap) of the dielectric columns 20, it results that there is shown a wavelength characteristic in which the peak of the localized surface plasmon exists in, for example, a range of 500 nm through 900 nm.

Further, unlike the propagating surface plasmon, the localized surface plasmon is a plasmon, which has no velocity and does not move, and when plotted on the graph of the dispersion relationship, the gradient becomes zero, namely ω/k=0.

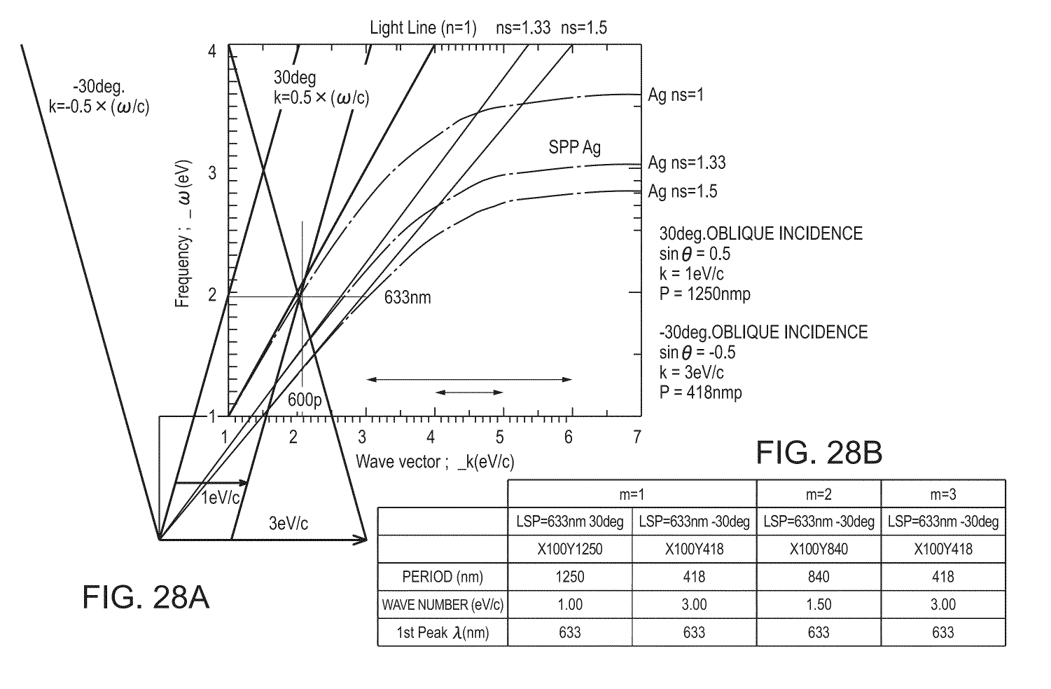

FIG. 8 is a graph showing dispersion curves of metals (Ag, Au) and a dispersion relationship between the localized plasmon and the incident light in the case in which the surrounding refractive index is 1. The optical element 100 according to the present embodiment causes the electromagnetic coupling between the propagating surface plasmon and the localized surface plasmon to thereby obtain an extremely high enhancement degree of the electric field. Specifically, one of the features of the optical element 100 according to the present embodiment is to make the straight line of the diffracted light and the dispersion curve of the SPP of the metal intersect with each other in the vicinity of the point, where the maximum or the local maximum enhancement degree is obtained in the localized surface plasmon generated in the second metal layers 30 (the first metal rows 31), in the graph of the dispersion relationship instead of setting the intersection of the straight line of the diffracted light and the dispersion curve of the SPP of the metal to an arbitrary point (see FIGS. 28A-B).

In other words, in the optical element 100 according to the present embodiment, it is designed in the graph of the dispersion relationship that the straight line of the diffracted light passes through the vicinity of the intersection between the dispersion curve of the SPP of the metal and the angular frequency (the line labeled LSP and parallel to the horizontal axis on the graph of the dispersion relationship in FIG. 8) of the incident light at which the maximum or the local maximum enhancement degree is obtained in the localized surface plasmon generated in the second metal layers 30 (the first metal rows 31).

Here, when converted into wavelength, the vicinity of the intersection denotes the inside of a wavelength range of about ±10% of the wavelength of the incident light, or the inside of a wavelength range of about ±P1 (the width of the pitch P1 of the second metal layers 30 in the first metal row 31) of the wavelength of the incident light.

Although in Formula 3, Formula 4, and Formula 2 described above, the condition for the propagating surface plasmon to be excited is described assuming the angular frequency of the incident light to be input to the first metal layer 10 as ω, in order to cause the hybrid (the interaction) between the localized surface plasmon and the propagating surface plasmon, in the optical element 100 of the present embodiment, the symbol ω Formula 3, Formula 4, and Formula 2 described above becomes the angular frequency of the incident light providing the maximum or the local maximum enhancement degree in the localized surface plasmon generated in the second metal layers 30 (the first metal rows 31) or the angular frequency in the vicinity thereof.

Therefore, in the case of assuming the angular frequency of the localized surface plasmon excited in the first metal rows 31 as ω, if Formula 2 described above is satisfied, the hybrid of the localized surface plasmon and the propagating surface plasmon can be generated.

Therefore, by assuming the angular frequency of the localized surface plasmon generated in the first metal rows 31 having the second metal layers 30 arranged at the pitch P1 as ω, and arranging that the straight line of the diffracted light (the order is m), which has entered the virtual diffraction grating having the pitch Q at the irradiation angle θ, and has then been diffracted, passes through the vicinity of the position of ω of the dispersion curve of the SPP of the metal in the graph of the dispersion relationship (making Formula 2 be satisfied), the hybrid of the localized surface plasmon and the propagating surface plasmon can be generated, and thus, an extremely high enhancement degree can be obtained. In other words, in the graph of the dispersion relationship shown in FIG. 8, by changing the gradient, the intercept, or the gradient and the intercept of the light line to thereby change the light line so as to pass through the vicinity of the intersection between the SPP and the LSP, the hybrid of the localized surface plasmon and the propagating surface plasmon can be generated, and thus, an extremely high enhancement degree can be obtained.

### 1.4.2. Pitch P2

The pitch P2 between the first metal rows 31 is set in the following manner. In the case of normal incidence (the incident angle θ=0), and using the first order diffracted light (m=0), Formula 2 can be satisfied by setting the pitch P2 to the pitch Q. However, depending on the incident angle θ and the order m of the diffracted light to be selected, it results that the pitch Q, which can satisfy Formula 2, has a certain range. It should be noted that although it is preferable for the incident angle θ on this occasion to be the tilted angle from the thickness direction toward the second direction, it is also possible to adopt the tilted angle toward the direction including the component of the first direction.

Therefore, taking the requirement of the vicinity of the intersection described above (the range of ±P1) into consideration, the range of the row pitch P2 with which the hybrid of the localized surface plasmon and the propagating surface plasmon can be generated is obtained as Formula 6.

Q−P1≦P2≦Q+P1 (6)

On the other hand, although the pitch P2 is the pitch in the second direction between the first metal rows 31, regarding the pitch between the two second metal layers 30 respectively belonging to the first metal rows 31 adjacent to each other, the line connecting the two second metal layers 30 to each other can be tilted with respect to the second direction depending on the way of selecting the two second metal layers 30. In other words, it is possible to select the two second metal layers 30 respectively belonging to the first metal rows 31 adjacent to each other so as to have a distance longer than the pitch P2. In FIG. 2, there are drawn auxiliary lines for explaining the above, and the two second metal layers 30, which are distant from each other with a distance longer than the pitch P2 along the directions tilted with respect to the second direction, can be selected from the first metal rows 31 adjacent to each other. As already described, since the first metal rows 31 adjacent to each other are the first metal rows 31 the same as each other, the arrangement of the second metal layers 30 viewed from the thickness direction can be assumed as the two-dimensional lattice taking the positions of the second metal layers 30 as the lattice points. In such a case, it results that the distance (diffraction grating) longer than the pitch P2 exists in the two-dimensional lattice.

Therefore, the diffracted light due to the diffraction grating having the distance larger than the pitch P2 can be expected to the matrix of the second metal layers 30 arranged at the pitch P1 and the pitch P2. Therefore, the inequality on the left side of Formula 6 can be changed to P1<P2. In other words, even in the case in which the row pitch P2 is smaller than Q−P1 in Formula 6, there can exist the diffraction grating having the pitch Q, which can satisfies Formula 2, and therefore, the hybrid of the localized surface plasmon and the propagating surface plasmon can be generated. Therefore, it results that the pitch P2 can have a value smaller than Q−P1, and it is only required to satisfy the relationship of P1<P2.

According to the above, it results that if the pitch P2 between the first metal rows 31 in the optical element 100 according to the present embodiment satisfies the relationship of Formula 1 below, the hybrid of the localized surface plasmon and the propagating surface plasmon can be generated.

P1<P2≦Q+P1 (1)

### 1.4.3. Structural Features and Generation Positions of Hotspots

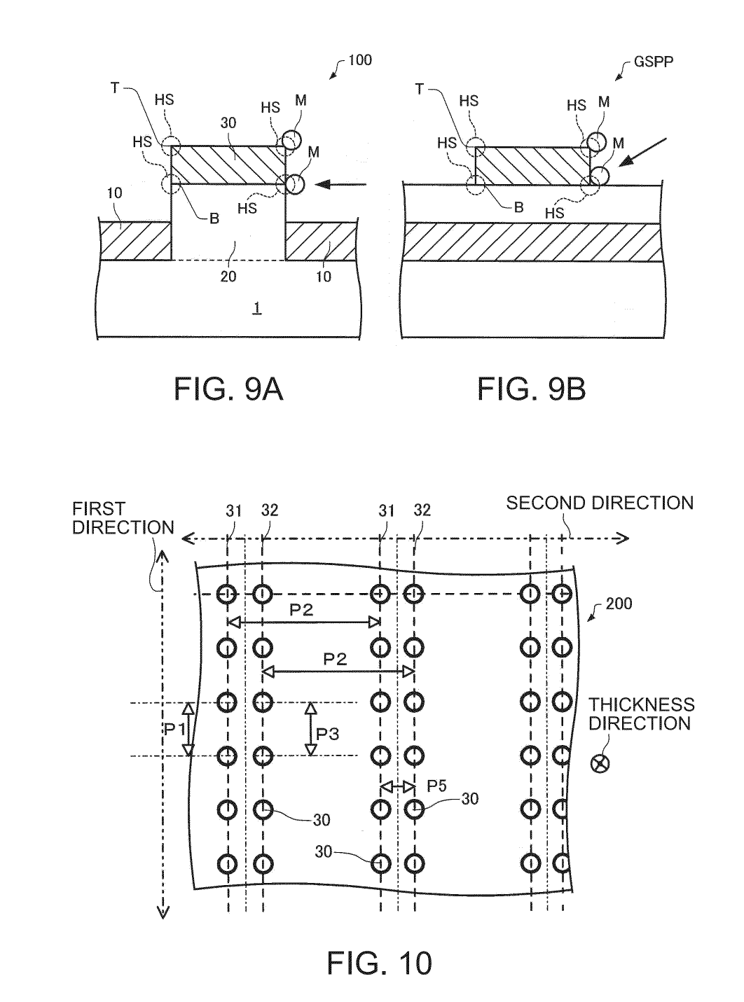

FIGS. 9A and 9B are diagrams each schematically showing a part of the optical element 100 according to the present embodiment in an enlarged manner in comparison with a GSPP model. FIG. 9A shows a structure of the essential part of the optical element according to the invention, and FIG. 9B is a schematic diagram showing the essential part of a typical GSPP structure. As shown in FIG. 9A, in the case in which the contour of the second metal layer 30 in the planar view is the same as the contour of the dielectric column 20 in the optical element 100 according to the present embodiment, it becomes easy for end portions in the planar view of the second metal layer 30, which are the lower portions (hereinafter referred to as “bottom ends” of the second metal layer 30 in some cases (denoted with the reference symbol B in the drawings)) on the substrate 1 side to have contact with an object M to be the measurement object compared to the corresponding positions of the GSPP model shown in FIG. 9B.

Specifically, in the optical element 100 according to the present embodiment, there is no structure such as a dielectric body in an area, which is located outside the contour of the second metal layers 30 viewed in a planar manner, and located on the lower side of the second metal layers 30 in the cross-sectional view. In contrast, in the GSPP model, a dielectric layer (an SiO₂ layer) exists in an area located outside the contour of the Ag particles viewed in a planar manner, and located on the lower side of the Ag particles in the cross-sectional view. Therefore, in the case in which the object M (a virus or a compound) to be the measurement object approaches the second metal layer 30, although the object M can easily have contact with the bottom end B in the optical element 100 according to the present embodiment, in the case of the GSPP model, since the SiO₂ layer exists under the position corresponding to the bottom end of the Ag particle to thereby narrow the path for the object M to approach to make it difficult for the object M to enter the path, it becomes difficult for the object M to have contact with the position corresponding to the bottom end of the Ag particle.

On the other hand, in the case in which the second metal layers 30 are arranged so as to satisfy the condition described above, the hotspots HS (the areas each presenting a high electric field enhancement degree) to be generated in the vicinity of one second metal layer 30 are generated at the bottom ends B, and the end portions in the planar view of the second metal layer 30 and located in the upper parts (top ends T) on the side distant from the substrate 1. In the GSPP model, the hotspots are similarly generated at positions corresponding respectively to the bottom ends and the top ends of the Ag particles (see FIGS. 9A and 9B).

Although a magnitude relation occurs in the intensity of the hotspot between the bottom end B and the top end T in some cases due to a variety of conditions, since the object M can have contact with both of the hotspots HS in the optical element 100 according to the present embodiment, a higher value can be obtained as a total electric field enhancement degree compared to the GSPP model in which the object M is difficult to bring into contact with the positions corresponding to the bottom ends.

Therefore, according to the optical element 100 of the present embodiment, in addition to the analysis of a small sample in the order of several nanometers such as a noble gas, it is possible to perform an accurate qualitative and quantitative analysis even on a measurement target substance having a large size no smaller than 5 nm such as a virus with a diameter of 20 through 100 nm.

### 1.5. Modifications and Other Configurations

### 1.5.1. Modifications

In the optical element according to the present embodiment, it is also possible to further include second metal rows 32 each constituted by a plurality of second metal layers 30 arranged in the first direction at a third pitch P3. Such second metal rows 32 are arranged in the second direction at the second pitch P2, and are arranged together with the first metal rows 31 alternately side by side in the second direction.

The second metal row 32 can be the same in configuration as the first metal row 31, or can be different in configuration from the first metal row 31. It is possible to arrange the second metal row 32 so as to correspond to each of the first metal rows 31, or to arrange a plurality of second metal rows 32 so as to correspond to each of the first metal rows 31. Further, a distance (a pitch P5) in the second direction between the second metal row 32 and the first metal row 31 can be a size no lower than 1% and no higher than 50% of the pitch P2. Further, the pitch P5 can be set independently of the pitch P1 in the first direction of the second metal layers 30.

Further, in the case in which the plurality of second metal rows 32 is disposed, those can be arranged separately from each other in the second direction with a distance no lower than 1% and no higher than 50% of the pitch P2. It should be noted that in the case in which the second metal row 32 has a similar configuration to that of the first metal row 31, and is disposed at the position distant from the first metal row 31 in the second direction as much as 50% of the pitch P2 (the case in which the pitch P5 is a half as long as the pitch P2), since the case is identical to the case in which the first metal rows 31 are arranged at a pitch a half as long as the pitch P2, the second metal rows 32 arranged in such a manner are assumed as the first metal rows 31.

At least one of the size (dimension), the shape, and the height of the location can be equal, or can be different between the second metal layer 30 belonging to the first metal row 31 and the second metal layer 30 belonging to the second metal row 32 provided that the peak wavelengths of the localized surface plasmons generated in the respective second metal layers 30 roughly coincide with each other.

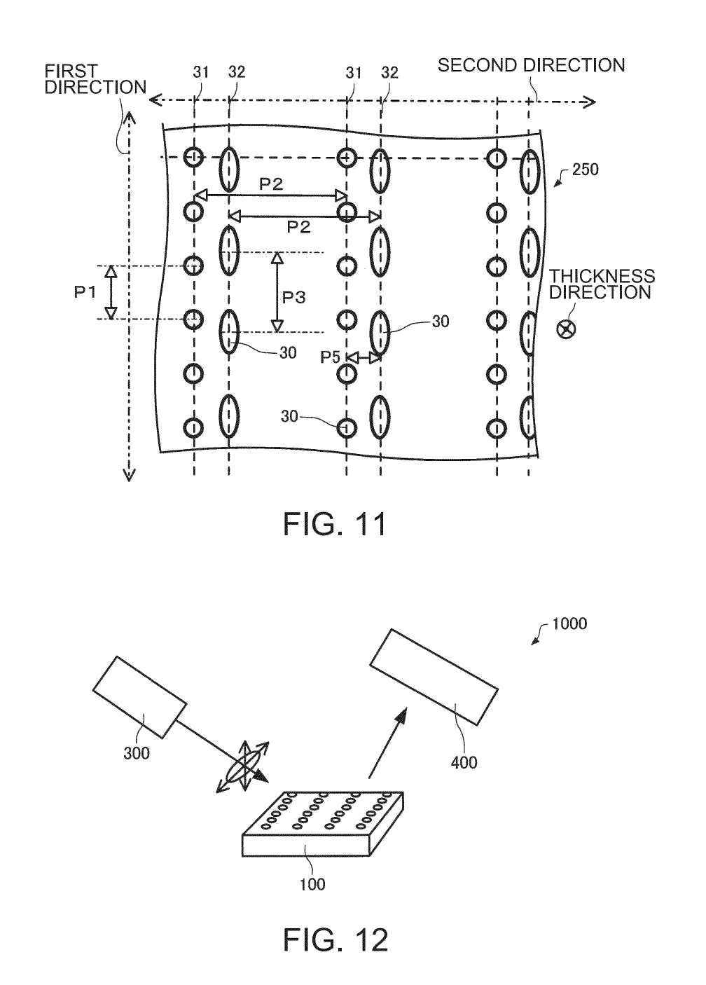

FIGS. 10 and 11 are schematic diagrams each showing an example of the second metal rows 32. FIG. 10 is a schematic diagram showing an example of an optical element 200 including the second metal rows 32 each constituted by a plurality of second metal layers 30 arranged side by side in the first direction at the pitch P3 equal in dimension to the first pitch P1. FIG. 11 is a schematic diagram showing an example of an optical element 250 including the second metal rows 32 each constituted by a plurality of second metal layers 30 arranged side by side in the first direction at the pitch P3 different in dimension from the first pitch P1. As described above, the pitch P3 can be the same as pitch P1, or can also be different from the pitch P1. Further, in the case in which a plurality of second metal rows 32 is disposed, the pitch P3 can be equal or different between the second metal rows 32.

Similarly to the optical element 100 described above, in the optical element 200 and the optical element 250 according to such modified examples, it is also possible to enhance the light at an extremely high enhancement degree based on the plasmons excited by light irradiation. Further, according to the analysis device equipped with such optical elements, it is possible to increase the freedom in adjusting the enhancement degree profile of the optical element in accordance with the wavelength of the scattering light depending on the substance to be the analysis object. Thus, a sufficiently high plasmon enhancement effect can be exerted on a wide variety of analysis objects.

In the example shown in FIG. 10, the second metal row 32 has a similar configuration to that of the first metal row 31. Specifically, the second metal layers 30 belonging to the second metal row 32 each have the same shape as that of the second metal layer 30 belonging to the first metal row 31, and the pitch at which the second metal layers 30 arranged side by side in the first direction is the same between the first and second metal rows (i.e., P1=P3). Further, in the case of this example, the second metal layer 30 of the first metal row 31 and the second metal layer 30 of the second metal row 32 are arranged so as to be closest to each other (so as to have the positions in the first direction aligned with each other). However, it is also possible to arrange the second metal layer 30 belonging to the second metal row 32 and the second metal layer 30 belonging to the first metal row 31 so that the positions in the first direction of the second metal layers 30 are shifted from each other.

Further, in the case in which the first metal rows 31 each having the second metal layers 30 arranged side by side in the first direction at the pitch P1, and the second metal rows 32 each having the second metal layers 30 arranged side by side in the first direction at the pitch P1 are arranged, it is possible to obtain a similar advantage to the advantage obtained in the case in which the first metal rows 31 are arranged in the second direction at a pitch a half as long as the pitch P2. Specifically, in this case, although depending on the distance in the second direction between the first metal row 31 and the second metal row 32, there can be expected an advantage that, for example, the peak wavelength characteristic becomes broad, and the hotspot density (HSD) is doubled although the enhancement degree is lowered.

Further, in the example shown in FIG. 11, the second metal row 32 is provided with a configuration different in shape and pitch from the configuration of the first metal row 31. Specifically, the second metal layers 30 belonging to the second metal row 32 each have a different shape from that of the second metal layer 30 belonging to the first metal row 31, and the pitch at which the second metal layers 30 arranged side by side in the first direction is different between the pitch P1 of the first metal row 31 and the pitch P3 of the second metal row 32 (i.e., P1<P3).

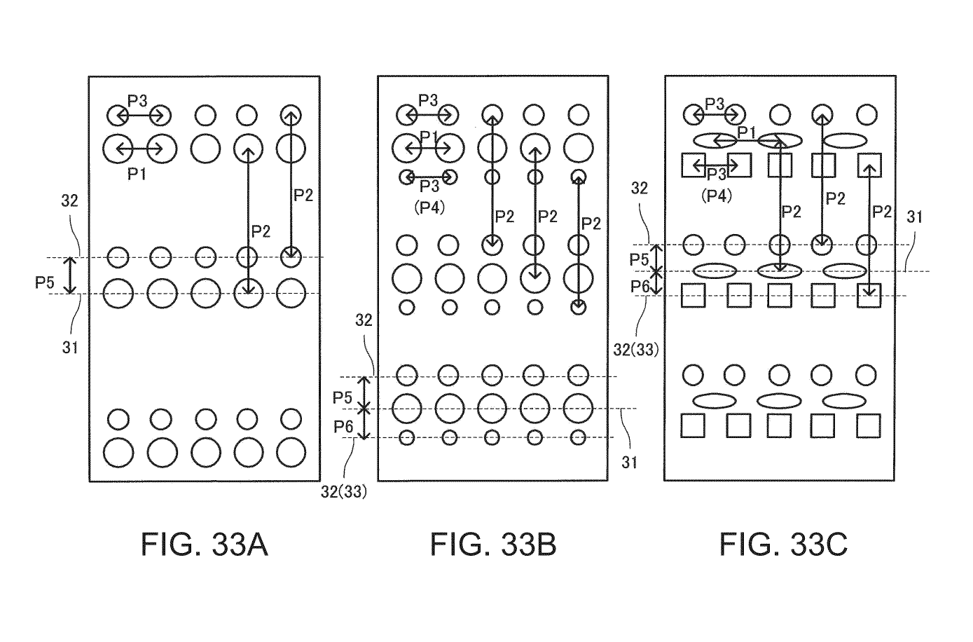

It should be noted that the case in which two sets of second metal rows 32 are formed (i.e., a system including three sets of metal rows) as one configuration of the case in which a plurality of sets of such second metal rows 32 is formed will further be explained in the paragraph of “4. Experimental Examples” (FIGS. 33A to 33C) described later.

The examples shown in FIGS. 10 and 11 are each for showing an example, and such second metal rows 32 can arbitrarily be arranged taking the excitation wavelength to be applied, the wavelength of the Raman scattering light, and so on into consideration.

### 1.5.2. Covering Layer

The optical element 100 according to the present embodiment can include a covering layer if desired. Although not shown in the drawings, the covering layer can be formed so as to cover upper surfaces of the second metal layers 30. Further, the covering layer can also be formed so as to expose the side surface, the top ends T, and the bottom ends B of each of the second metal layers 30 and cover other configurations.

The covering layer has a function of, for example, mechanically and chemically protecting the second metal layers and other configurations from the environment. The covering layer can be formed using a method such as an vapor deposition process, a sputtering process, a CVD process, or a variety of coating processes, and can also be formed using a patterning technology if desired. The thickness of the covering layer is not particularly limited. The material of the covering layer is not particularly limited, but the covering layer can be formed not only of an insulating body such as SiO₂, Al₂O₃, or TiO₂, but also of ITO, metal such as Cu or Al, or a polymer. It is preferable to have a small thickness no larger than several nanometers.

In the case of providing the covering layer, the excitation peak frequency of the localized surface plasmon generated in the second metal layers 30 is shifted in some cases, which should be taken into consideration in some cases when obtaining the peak excitation wavelength of the localized surface plasmon in the setting of the pitch P2.

### 1.6. Design Method of Optical Element

The optical element 100 according to the present embodiment has the structure described above, and a design method of the optical element will more specifically be described below.

The optical element is designed (see FIG. 8) including the feature of selecting the pitch P2 so as to make the straight line of the diffracted light of the localized surface plasmon generated in the first metal rows 31 intersect with the vicinity of the intersection between the dispersion curve of the metal constituting the first metal layer 10 and the angular frequency [ω(eV)] of the light for providing a peak of the localized surface plasmon excited in the second metal layers 30 (the first metal rows 31) arranged side by side at the pitch P1 in the graph of the dispersion relationship (having the vertical axis representing angular frequency [ω(eV)] and the horizontal axis representing the wave vector [k(eV/c)]).

The design method of the optical element according to the present embodiment includes the processes described below.

The excitation wavelength dependency of the localized surface plasmon in the second metal layers 30 (the first metal rows 31) is studied to figure out the wavelength (referred to as a peak excitation wavelength in some cases in the present specification) at which the second metal layers 30 generates the maximum or a local maximum of the localized surface plasmon. As already described, although the localized surface plasmon varies in accordance with the material, the shape, and the arrangement of the second metal layers 30, presence or absence of the second metal rows 32, and other configurations, the peak excitation wavelength can be obtained by actual measurements or calculations.

The dispersion curve of the metal constituting the first metal layer 10 is figured out. This curve can be obtained from literatures or the like based on the material of the first metal layer 10, and can also be obtained by calculations. It should be noted that it is understood from the left-hand side of Formula 2 that the dispersion relationship is varied in accordance with the surrounding refractive index ε of the first metal layer 10.

The peak excitation wavelength and the dispersion curve thus obtained are plotted on the graph (having the vertical axis representing the angular frequency [ω(eV)], and the horizontal axis representing the wave vector [k(eV/c)]). On this occasion, the peak excitation wavelength of the localized surface plasmon appears on the graph as a line parallel to the horizontal axis. Although already described, since the localized surface plasmon is a plasmon, which has no velocity, and does not move, in the case of being plotted on the graph of the dispersion relationship, the gradient (ω/k) becomes zero.

The incident angle θ of the incident light and the order m of the diffracted light to be used are determined, then the value of Q is obtained from Formula 2, and the pitch P2 is selected so as to satisfy the condition of Formula 1 to arrange the first metal rows 31.

By performing at least the processes described above to set the pitch P1 and the pitch P2, the LSP and the PSP become in the interactive (hybrid) state, and therefore, the optical element having an extremely high enhancement degree can be designed.

### 1.7. Enhancement Degree

Due to mesh positions of the FDTD calculation, the relationship between the intensity of the electric field Ex in the X direction (the first direction) and the intensity of the electric field Ez in the Z direction (the thickness direction), namely the vector, is changed. In the case of using the linearly-polarized light in the X direction as the excitation light, the electric field Ey in the Y direction (the second direction) can nearly be neglected. Therefore, the enhancement degree can be figured out using a square-root of the sum of the squares of Ex and Ez, namely SQRT(Ex²+Ez²). According to the process described above, the comparison with each other can be performed as scalar values of the localized electric fields.

It should be noted that in the experimental examples, drawings, and so on of the present specification, the first direction is referred to as the X direction in some cases, and the direction is expressed with a description of “X” in some cases. Further, the second direction is referred to as the Y direction in some cases, and the direction is expressed with a description of “Y” in some cases. Further, the thickness direction of the element is referred to as the Z direction in some cases, and the direction is expressed with a description of “Z” in some cases.

The SERS (Surface Enhancement Raman Scattering) effect is expressed by Formula (a) below using the electric field enhancement degree Ei in the wavelength of the excitation light, the electric field enhancement degree Es in the wavelength after the Raman scattering, and the hotspot density (HSD) as the SERS EF (Enhancement Factors).

SERS EF=Ei²·Es²·HSD (a)

Here, for example, the Stokes scattering equal to or smaller than 1000 cm⁻¹ at the excitation wavelength of 600 nm can be approximated as follows since the difference between the scattering wavelength of 638 nm and the excitation wavelength is equal to or smaller than 40 nm.

Ei²·Es²≈Emax⁴

(Emax represents the maximum enhancement degree)

Therefore, Formula (a) can be modified to Formula (b) below.

SERS EF=Emax⁴·HSD (b)

In other words, the SERS (surface enhancement Raman scattering) can be thought to be what is obtained by multiplying the fourth power of the electric field enhancement degree due to the plasmon by the hotspot density.

It should be noted that in the experimental examples described later, regarding Formula (b) described above, the HSD is normalized to present the graphical description using the definition of Formula (c).

SERS EF=(Ex⁴+Ez⁴)/(unit area) (c)

In the case of considering the enhancement degree of the optical element 100, one should consider the so-called hotspot density (HSD). Specifically, the enhancement degree of the light due to the optical element 100 depends on the number of the second metal layers 30 per unit area of the optical element 100. In the optical element 100 according to the present embodiment, the pitch P1 and the pitch P2 are determined so that the relationships of Formula 1 and Formula 2 described above are fulfilled. Therefore, in view of the HSD, it results that the SERS enhancement degree of the optical element 100 is proportional to (Ex⁴+Ez⁴)/(P1·P2).

### 1.8. Incident Light

The wavelength of the incident light to be input to the optical element 100 is not limited as long as the localized surface plasmon is generated and the relationship of Formula 2 described above can be satisfied, and an electromagnetic wave including ultraviolet light, visible light, and infrared light can be adopted. In the present embodiment, the incident light can also be linearly-polarized light. Further, the incident light can also be linearly-polarized light with the electric field having the same direction as the first direction (the direction in which the first metal rows 31 extend) of the optical element 100, or can also be linearly-polarized light with the electric field having the same direction as the second direction (the direction in which the first metal rows 31 are arranged side by side) of the optical element 100. Further, the incident light can also be circularly-polarized light. Further, the design for obtaining an extremely high enhancement degree of the light by the optical element 100 is also possible by arbitrarily combining the incident light beams different in polarization direction from each other.

### 1.9. Design of Enhancement Degree Profile

In the case of using the optical element 100 for the enhancement of the Raman scattering light in an analysis device 1000 according to the present embodiment, it is preferable to set the arrangement of the second metal layers 30 of the optical element 100 in the following manner.

In general, the wavelength or the wave number of the Raman scattering light extends over a wide band. In the case in which only the excitation light as the linearly-polarized light in a specific direction is applied to the optical element 100, it is unachievable to entirely cover such a wide band with a high-enhancement degree area in most cases. Further, in such a case, it is difficult to obtain a high enhancement degree in the band not covered even by, for example, elongating the integration time.

In the optical element 100 according to the present embodiment, when the incident light as the linearly-polarized light in the same direction as the first direction is input, a high enhancement degree can be obtained, and two peaks appear in the enhancement degree profile, but in some cases, it becomes difficult to enhance the entire band of the Raman scattering light. However, incident light as the linearly-polarized light in the same direction as the second direction can further be input to the optical element 100 according to the present embodiment. In the case of using the incident light as the linearly-polarized light in the same direction as the second direction, although two peaks appear in the enhancement degree profile, since the peak wavelengths are different from the case of the linearly-polarized light in the first direction, the band where the certain enhancement degree can be obtained can be broadened in many cases.

In the analysis device 1000 according to the present embodiment, by superposing the two enhancement degree profiles obtained by the linearly-polarized light beams in the directions identical respectively to the first direction and the second direction, it is possible to realize the configuration capable of obtaining a high enhancement degree in a broader band. These two enhancement degree profiles can be adjusted using, for example, the arrangement and the material of the second metal layers 30, and the thickness and the material of the first metal layer 10 in the optical element 100.

Similarly, circularly-polarized incident light can also be input to the optical element 100 according to the present embodiment. Since the incident light as the circularly-polarized light includes the polarization component along the first direction and the polarization component along the second direction, the superposition of the enhancement degree profiles occurs, and thus a high enhancement degree can be obtained in a broad band in some cases.

In the light emitting device 100 according to the present embodiment, the enhancement degree profiles can be designed in the following manner.

For example, in the case of using the analysis device 1000 according to the present embodiment for the detection of a known substance, the setting is performed so that the superposition of the two enhancement degree profiles respectively obtained by the linearly-polarized light beams in the first direction and the second direction of the optical element 100 has a high value in the area of the wavelength or the wave number of the Raman scattering light of the present substance. According to such a setting, the detection of the present substance can be performed at high sensitivity.

Further, in the case of using the analysis device 1000 according to the present embodiment for the detection or the identification of an unknown substance, the setting is performed so that the superposition of the two enhancement degree profiles respectively obtained by the linearly-polarized light beams in the first direction and the second direction of the optical element 100 has a high value in a band as broad as possible. According to such a setting, the detection and the identification of the present substance can be performed at high sensitivity.

According to the analysis device 1000 explained hereinabove, since the enhancement degree profile of the light based on the plasmon of the optical element can be set to have a high value in a broad band, the detection and the measurement of a wide variety of trace substances can easily be performed. Further, it is also possible for the analysis device 1000 according to the present embodiment to be provided with other arbitrary constituents not shown such as a housing or an input/output device.

### 1.10. Manufacture of Optical Element

The optical element 100 according to the present embodiment can be manufactured through a process of performing injection molding using a mold made of Ni, as an example. Specifically, a thermal oxidation treatment is performed on a silicon wafer, a surface of the silicon wafer is coated with a resist, positions corresponding to the dielectric columns 20 are exposed to an electron beam (EB), and then patterning is performed on the silicon oxide. Then, after the surface is coated with an Ni film using an electroless Ni plating process or a sputtering process, electrocasting of Ni is performed. Then, by separating the silicon wafer, the Ni mold provided with recessed portions corresponding to the arrangement and the shapes of the dielectric columns 20 can be obtained.

Subsequently, by forming PMMA (polymethacrylic acid) or PC (polycarbonate) by injection molding, or forming UV curable resin using the Ni mold, a structure provided with the dielectric columns 20 is formed on the substrate.

Subsequently, by forming the metal thin film capable of generating the surface plasmon made of Ag, Au, Al, Cu, or the like on the substrate provided with the dielectric columns 20 with a thickness of about 20 nm using, for example, an ion-beam sputtering process high in anisotropy, the optical element according to the present embodiment can be manufactured.

Further, as the manufacturing method of the optical element 100, it is also possible to adopt a process of coating a glass substrate with a resist to form a layer with a first thickness, exposing the positions corresponding to the dielectric columns 20 to the electron beam (EB), and then performing an etching process and a post-baking process. Then, the resist is applied to have a second thickness, then the positions corresponding to the dielectric columns 20 are exposed, and then the etching process is performed. Thus, the two types of recessed portions different in depth are formed, and the analysis element having the dielectric columns 20 different in height can be manufactured through the similar process to the above performed after such a process.

These manufacturing methods are illustrative only, and the optical element 100 can be manufactured using other arbitrary methods. Further, in the case of using the manufacturing methods described above as an example, the optical element 100 having the dielectric columns 20 and the second metal layers 30 different in shape or height arranged in the same element can easily be manufactured.

### 1.11. Functions and Advantages

The optical element 100 according to the present embodiment has the following features. The optical element 100 according to the present embodiment is capable to enhancing the light at an extremely high enhancement degree and a high HSD based on the plasmon excited due to the light irradiation. Further, in the optical element 100 according to the present embodiment, the positions where the hotspots are generated are set to the bottom ends B and the top ends T of the second metal layers 30 to thereby obtain a geometry in which the object M to be the measurement object can have contact with both of the hotspots. Therefore, compared to the GSPP model in which it is difficult for the object M to contact the bottom ends, a larger value can be obtained as a total electric field enhancement degree.

The optical element 100 according to the present embodiment has a high enhancement degree, and can therefore be used for a sensor for sensitively, accurately, promptly, and easily detecting a biologically-relevant substance such as bacteria, a virus, protein, nucleic acid, or a variety of types of antigen and antibody, or a variety of types of compound including an inorganic molecule, an organic molecule, and a polymer in the fields of, for example, medical services and health, environment, food, and public security. For example, by coupling an antibody to the second metal layer 30 of the optical element 100 according to the present embodiment, and then obtaining the enhancement degree at this moment, it is possible to investigate the presence or absence and the amount of an antigen based on the change in enhancement degree in the case in which the antigen is coupled to the antibody. Further, the optical element 100 according to the present embodiment can be used for enhancing the Raman scattering light of a trace substance using the enhancement degree of the light of the optical element 100.

### 2. ANALYSIS DEVICE

FIG. 12 is a diagram schematically showing a part of interconnection structure of the organic EL device according to the present embodiment.

The analysis device 1000 according to the present embodiment is provided with the optical element 100 described above, a light source 300 for irradiating the optical element 100 with the incident light, and a detector 400 for detecting the light emitted from the optical element 100. It is also possible for the analysis device 1000 according to the present embodiment to be provided with other arbitrary constituents not shown in the drawings.

### 2.1. Optical Element

The analysis device 1000 according to the present embodiment is provided with the optical element 100. Since the optical element 100 is substantially the same as the optical element 100 described above, the detailed explanation thereof will be omitted.

The optical element 100 plays a function of enhancing the light, a function as a sensor, or both of the function of enhancing the light and the function as the sensor in the analysis device 1000. The optical element 100 can also be used while having contact with a sample to be an object of analysis of the analysis device 1000. The arrangement of the optical element 100 in the analysis device 1000 is not particularly limited, and it is also possible for the optical element 100 to be mounted on a stage or the like the mounting angle of which can be adjusted.

### 2.2. Light Source

The analysis device 1000 according to the present embodiment is provided with the light source 300. The light source 300 irradiates the optical element 100 with the incident light. The light source 300 can emit the light (the linearly-polarized light in the direction identical to the first direction (the direction along which the second metal layers 30 are arranged side by side, and the first metal rows 31 extend) of the optical element 100) linearly polarized in the first direction, the light (the linearly-polarized light in the direction identical to the second direction (the direction along which the first metal rows 31 are arranged side by side, and which intersects with the direction along which the first metal rows 31 extend) of the optical element 100) linearly polarized in the second direction, or the circularly-polarized light.

In other words, the light source 300 can be provided with a configuration of irradiating the optical element 100 with the linearly-polarized light in the direction identical to the first direction, the linearly-polarized light in the direction identical to the second direction, or both of the linearly-polarized light in the direction identical to the first direction and the linearly-polarized light in the direction identical to the second direction, or a configuration of irradiating the optical element 100 with the circularly-polarized light. It is also possible to arrange that the tilt angle θ of the incident light emitted from the light source 300 from the thickness direction of the first metal layer 10 can arbitrarily be varied in accordance with the excitation condition of the surface plasmon of the optical element 100. The light source 300 can also be installed in a goniometer or the like.

The light emitted by the light source 300 is not particularly limited provided that the light can excite the surface plasmon of the optical element 100, and it is possible to use an electromagnetic wave including ultraviolet light, visible light, and infrared light. Further, the light emitted by the light source 300 can, but is not required to, be coherent light. Specifically, as examples of the light source 300, there can be cited a semiconductor laser, a gap laser, a halogen lamp, a high-pressure mercury lamp, a xenon lamp, and so on arbitrarily provided with a wavelength selective element, a filter, a polarizer, and so on.

Further, in the case in which the light source 300 is provided with the polarizer, a known device can be used as the polarizer, and it is also possible for the polarizer to arbitrarily be provided with a mechanism for rotating the polarizer. The light from the light source 300 acts as the excitation light to generate a concentration of the electric field due to the plasmon generated in the optical element 100, namely a so-called hotspot, and the weak Raman light of the substance adhering to the hotspot is enhanced by the electric field in the hotspot to thereby make it possible to detect the substance.

### 2.3. Detector

The analysis device 1000 according to the present embodiment is provided with the detector 400. The detector 400 detects the light emitted from the optical element 100. As the detector 400, for example, a charge coupled device (CCD), a photomultiplier tube, a photodiode, and an imaging plate can be used.

It is sufficient for the detector 400 to be disposed at the position where the detector 400 can detect the light emitted from the optical element 100, and the positional relationship with the light source 300 is not particularly limited. Further, the detector 400 can also be installed in a goniometer or the like.

### 3. ELECTRONIC APPARATUS

An electronic apparatus 2000 according to the present embodiment is provided with the analysis device 1000 described above, an operation section 2010 for performing an operation on health medical information based on the detection information from the detector 400, a storage section 2020 for storing the health medical information, and a display section 2030 for displaying the health medical information.

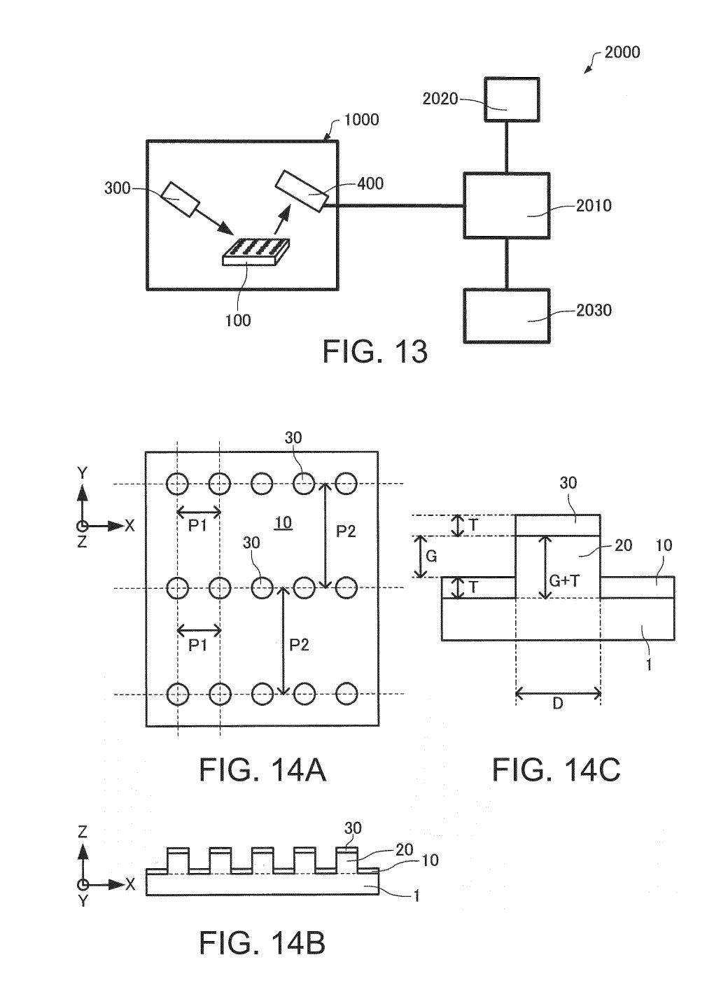

FIG. 13 is a schematic diagram of a configuration of the electronic apparatus 2000 according to the present embodiment. The analysis device 1000 corresponds to the analysis device 1000 described in the section of “2. Analysis Device,” and the detailed explanation will be omitted.

The operation section 2010 is, for example, a personal computer or a personal digital assistance (PDA), and receives the detection information (e.g., a signal) transmitted from the detector 400, and then performs the operation based on the detection information. Further, the operation section 2010 can also perform control of the analysis device 1000. For example, it is possible for the operation section 2010 to perform control of the output, the position, and so on of the light source 300 of the analysis device 1000, and control of the position of the detector 4000. The operation section 2010 can perform the operation on the health medical information based on the detection information from the detector 400. Then, the health medical information on which the operation has been performed by the operation section 2010 is stored in the storage section 2020.

The storage section 2020 is, for example, a semiconductor memory or a hard disk drive, and can also be configured integrally with the operation section 2010. The health medical information stored in the storage section 2020 is transmitted to the display section 2030.

The display section 2030 is constituted by, for example, a display panel (e.g., a liquid crystal monitor), a printer, a light emitting body, and a speaker. The display section 2030 displays or issues a notification based on, for example, the health medical information on which the operation has been performed by the operation section 2010 so that the user can recognize the content of the information.

As the health medical information, there can be included information related to presence or absence or an amount of at least one biologically-relevant substance selected from a group consisting of bacteria, a virus, a protein, a nucleic acid, and an antigen/antibody, or at least one compound selected from an inorganic molecule and an organic molecule.

### 4. EXPERIMENTAL EXAMPLES

Although some experimental examples will hereinafter be described, the invention is not at all limited by the following examples. The examples described hereinafter are simulations by a computer.

### 4.1. Outline of Calculations

In the calculations, FullWAVE, the FDTD software produced by Rsoft Design Group, Inc (CYBERNET SYSTEMS CO., LTD.), was used. Further, the mesh condition used was 1 nm minimum mesh unless described in the drawing, and the calculation time cT was set to 10 μm.

Further, the surrounding refractive index n was set to 1. Regarding the incident light, there was obtained the plotting obtained by separately calculating the case in which the incident light was assumed to be the normal incident light from the thickness direction (Z) of the light-transmitting layer and the linearly-polarized light in the direction identical to the first direction and the case in which the incident light was assumed to be the normal incident light from the thickness direction (Z) of the light-transmitting layer and the linearly-polarized light in the direction identical to the second direction, or the plotting obtained by calculating the case in which the incident light was assumed to be the normal incident light from the thickness direction (Z) of the light-transmitting layer and the circularly-polarized light.

It should be noted that in the graphs shown in each of the following experimental examples, there are used descriptions such as “X120Y600” or “X600Y120” as an explanatory note. For example, “X120Y600” denotes that the second metal layers 30 are arranged in the first direction (the X direction) at the pitch of 120 nm (the pitch P1), and in the second direction (the Y direction) at the pitch of 600 nm (the pitch P2).

For the sake of convenience of calculation, the incident light as the linearly-polarized light in the X direction is used in either of the cases, and those attached with the description of “X120Y600” are equivalent to the result obtained by the incident light as the linearly-polarized light in the “first direction” in the case in which the pitch P1 is 120 nm, and the pitch P2 is 600 nm, and those attached with the description of “X600Y120” are equivalent to the result obtained by the incident light as the linearly-polarized light in the “second direction” in the case in which the pitch P1 is 120 nm, and the row pitch P2 is 600 nm.

Further, for the sake of convenience of explanation, either of the X120Y600 model and the X600Y120 model is referred to as a single line model. Further, an X120Y120 model is referred to as a basic model, and an X600Y600 model is referred to as a hybrid model. Further, the case in which the excitation light polarized in the X direction (the first direction) is input to the single line model, namely X120Y600, is described as “PSP⊥LSP,” and the case in which the excitation light polarized in the Y direction (the second direction) is input is described as “PSP∥LSP.”

In the present experimental examples, the enhancement degree is expressed by SQRT(Ex²+Ez²). Here, Ex represents the electric field intensity in the polarization direction (the first direction) of the incident light, and Ez represents the electric field intensity in the thickness direction. It should be noted that in this case, the electric field intensity in the second direction is low, and is therefore out of consideration.

### 4.2. Experimental Example 1

### Comparison Between Structure According to the Invention and GSPP in Single Line Model

FIGS. 14A-C include a schematic diagram showing a model used for the simulation of the present experimental example. The dimensions of the present experimental example are designed on the assumption that the normal incident light having the excitation wavelength of around 633 nm is used. In the model of the present experimental example, there is assumed a substrate obtained by forming PMMA (polymethacrylic acid), PC (polycarbonate), or the like by injection molding, or forming UV (ultraviolet) curable resin using the metal mold provided with a recessed surface.

Specifically, there is assumed a structure obtained by forming protruding portions of PMMA so as to have a shape (a cylindrical shape having a diameter of 80 nm and a height of 80 nm) of 80 nm D, 80 nm T (G+T), and then forming an Ag layer (the first metal layer 10 and the second metal layers 30) having a thickness of 20 nm T using a deposition method with strong anisotropy so that Ag does not adhere to the side surfaces of the protruding portions. In this case, since the difference in height (the gap G) between the bottom of the Ag layer (the second metal layers 30) and the top of the Ag layer (the first metal layer 10) becomes 60 nm, in such a system, the description of 60G is provided to the drawing.

In contrast, as the GSPP model, there is assumed a structure obtained by forming SiO₂ as much as 20 nm on an Au film having a thickness equal to or larger than 100 nm, and then further forming Ag disks of 72 nm D, 20 nm T on SiO₂ thus formed in a regular manner.

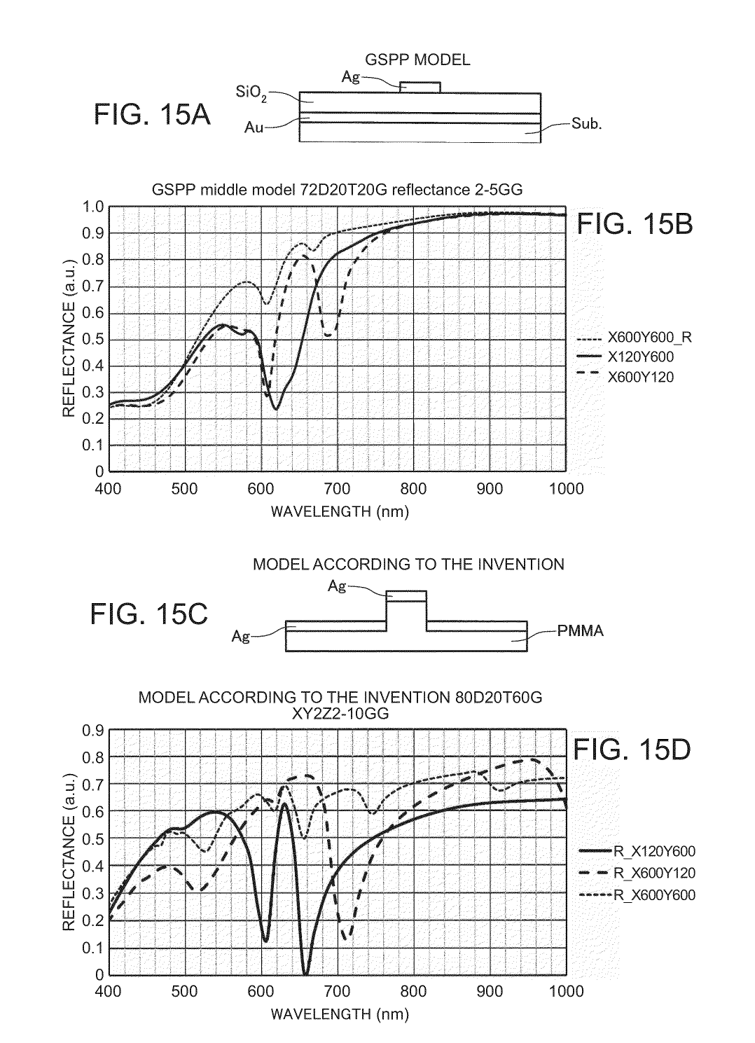

FIGS. 15A-D include graphs showing reflectance characteristics of the models according to the present experimental example. FIGS. 15A-D show the result of comparison of far field (reflectance) characteristics in each of the models. In FIGS. 15A-D, X120Y600 corresponds to PSP⊥LSP, X600Y120 corresponds to PSP∥LSP, and X600Y600 corresponds to hybrid, respectively. It should be noted that when the plasmon enhancement degree of the sensor increases, the intensity of reflected light is decreased, and therefore, the reflectance characteristic tends to be lowered.

According to FIGS. 15A-D, a marked difference was confirmed in the single line model in the case of PSP⊥LSP indicated by the solid line. Specifically, it was found out that in the case (the solid line) of PSP⊥LSP of the single line model of GSPP, there was one local minimum value of the reflectance, which was 0.24 at the excitation wavelength of 618 nm, while in the case of PSP⊥LSP of the single line model having the structure according to the invention, there were two local minimum values of the reflectance, which were 0.13 at 607 nm, and nearly 0 at 655 nm.

### Near Field Characteristics of Various Structures According to the Invention in Single Line Model

Then, near field characteristics corresponding to the reflectance characteristics were examined. The reflectance-wavelength characteristics in the far field and the SQRT(Ex²+Ez²) in the near field were compared in various structure models according to the invention. It should be noted that in the drawings, SQRT(Ex²+Ez²) is described simply as SQRT in some cases.

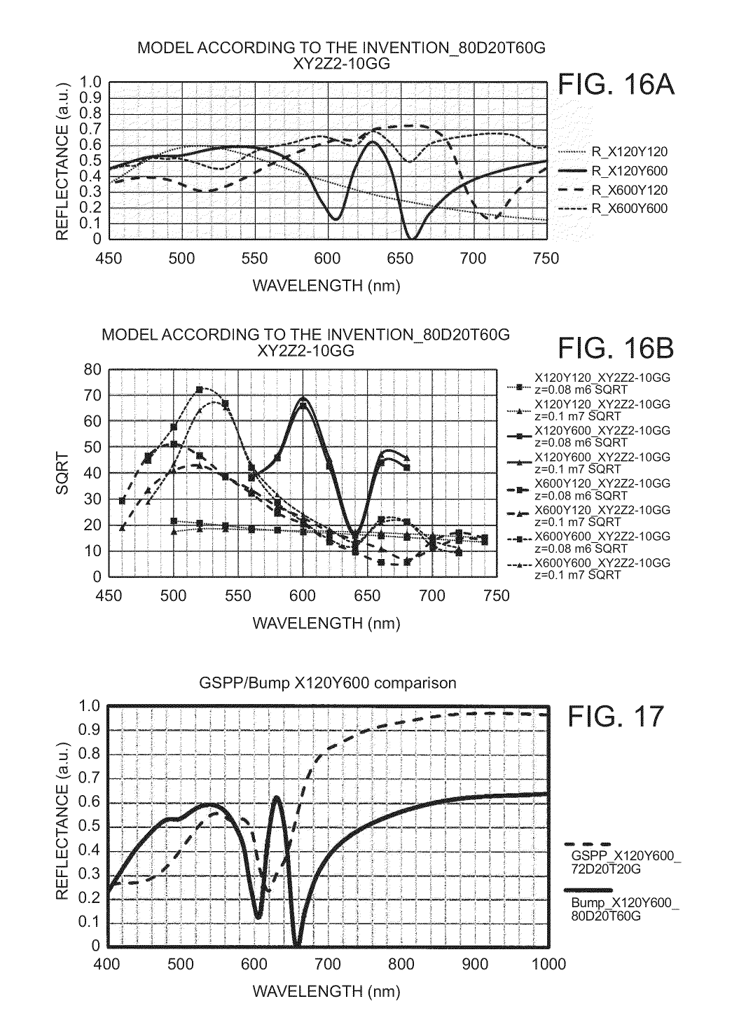

FIGS. 16A-B are a pair of graphs showing a correlation between the far field and the near field in the various structure models according to the invention. In the near field, there is shown the value of the square-root (=SQRT(Ex²+Ez²)) of Ex²+Ez². In FIGS. 16A-B, the values of SQRT(Ex²+Ez²) at the top end and the bottom end of the second metal layer (the Ag disk) are represented by ▴ and ▪, respectively.

According to FIGS. 16A-B, it is understood that the wavelength characteristics of the local minimum value of the far field representing the reflection characteristics and the wavelength characteristics of the enhancement degree of the near field representing the intensity of the near field closely coincide with each other. In the basic model having a high hotspot density (HSD) of X120Y120 at the excitation wavelength of 600 nm, SQRT(Ex²+Ez²)=18 is obtained at the excitation wavelength of 600 nm, while in the PSP⊥LSP model (X120Y600) of the single line, SQRT(Ex²+Ez²)=67 is obtained, which is 3.7 times as large as the value in the basic model.

When describing the enhancement degree of the excitation wavelength as Ei, the enhancement degree of the scattering wavelength after the Raman scattering as Es, the hotspot density as HSD, the SERS (Surface Enhancement Raman Scattering) effect (a Raman enhancement factor (Raman EF)) is proportional to |Ei²|*|Es²|*HSD. However, since the Raman scattering wavelength at 500 cm¹ in the case of the excitation wavelength of 633 nm is 654 nm having a shift amount of about nm, and the difference in the enhancement degree corresponding to the wavelength shift amount is negligible small, replacement of |Ei²|*|Es²|=|Emax⁴| is applied, and the comparison is performed assuming that the Raman EF is proportional to |Emax⁴|*HSD.

In the case of assuming the density of the basic model as 1, 18⁴=1×10⁵ is obtained in the basic model, and the density of the single line model becomes 120 nm/600 nm=1/5, and therefore, 67⁴/5=4×10⁶ is obtained in the single line model. Therefore, in the signal line model according to the invention, the SERS effect roughly 40 times as strong as the effect in the basic model can be expected.

It should be noted that in the hybrid model, the HSD is (120×120)/(600×600)=1/25 of that of the basic model, the enhancement degree (SQRT (Ex²+Ez²)) at the bottom end of Ag (the second metal layer 30) is 71.9, the enhancement degree (SQRT(Ex²+Ez²)) at the top end of Ag (the second metal layer 30) is 63.7, and therefore, the average of these values becomes 67.8. On the other hand, the Raman EF of the hybrid model is proportional to 67.8⁴/(5×5)=2.1×10⁷/25=8×10⁵, and is therefore 8 times as high as that of the basic model, but is about 1/5 times compared to the single line model.

Then, the near field in the two points each showing the local minimum value of the same PSP⊥LSP model was examined. Since the local minimum values were shown at 620 nm in the GSPP model, and at 600 nm in the model according to the invention, respectively, the near field is compared between these wavelength values.

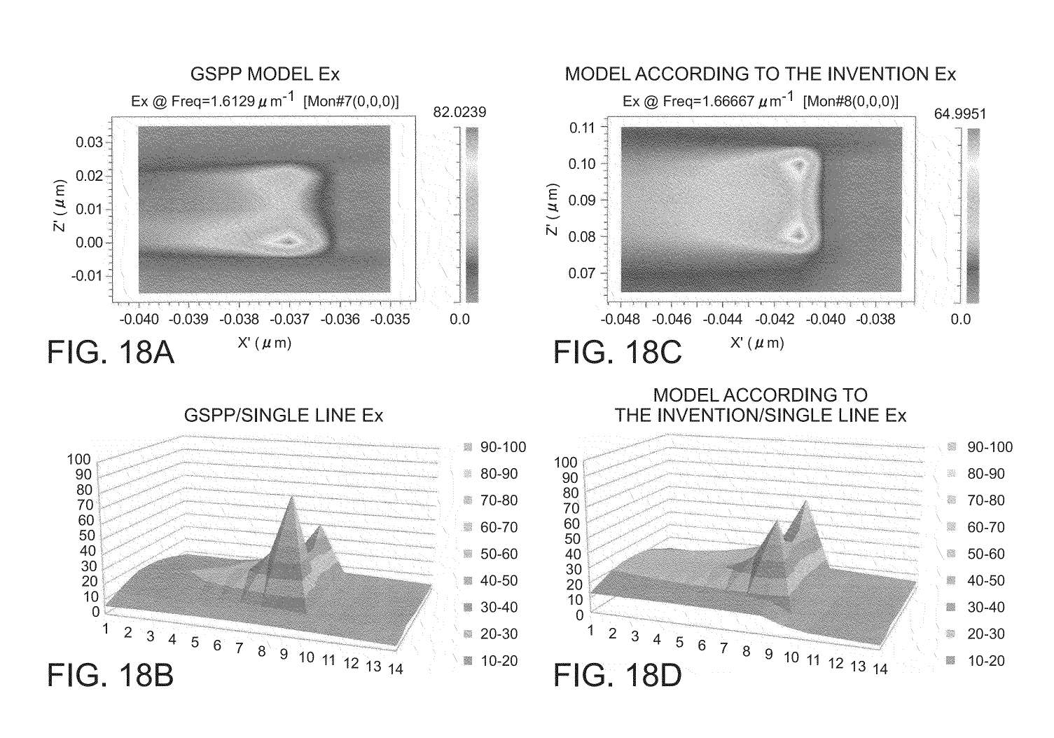

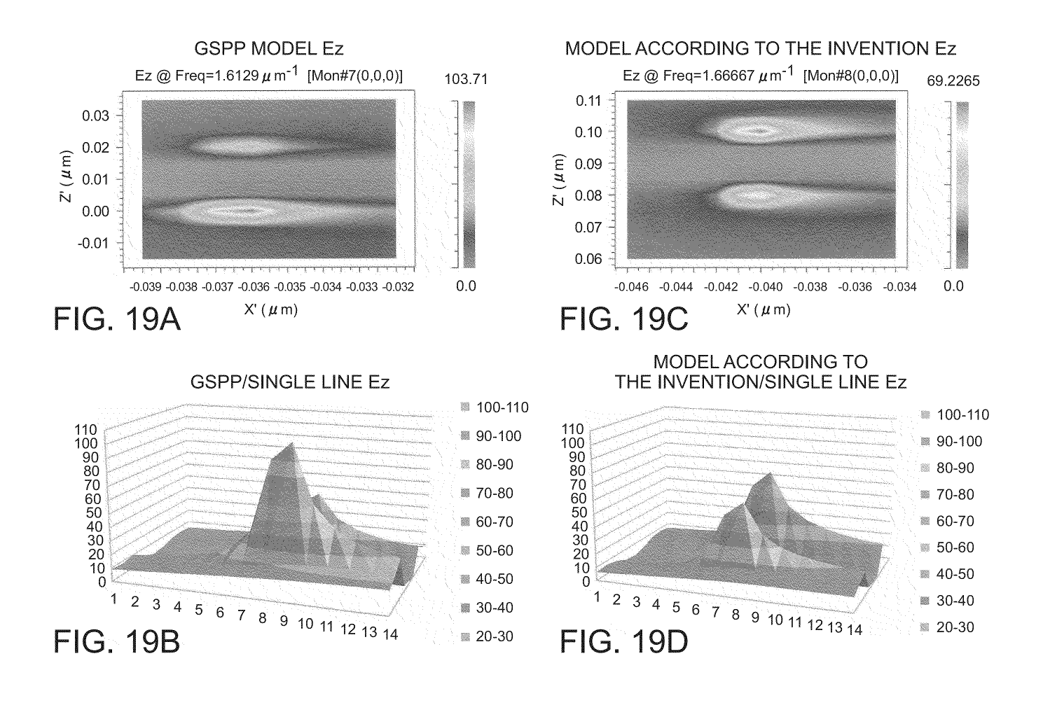

FIG. 17 is a graph showing the far field characteristics of the single line PSP⊥LSP model of GSPP and the single line PSP⊥LSP model according to the invention. FIGS. 18A-D are a set of diagrams showing distributions of Ex in the vicinities of the bottom end and the top end of the Ag layer (the second metal layer) of the single line PSP⊥LSP model of GSPP and the single line PSP⊥LSP model according to the invention. FIGS. 19A-D are a set of diagrams showing distributions of Ez in the vicinities of the bottom end and the top end of the Ag layer (the second metal layer 30) of the single line PSP⊥LSP model of GSPP and the single line PSP⊥LSP model according to the invention.

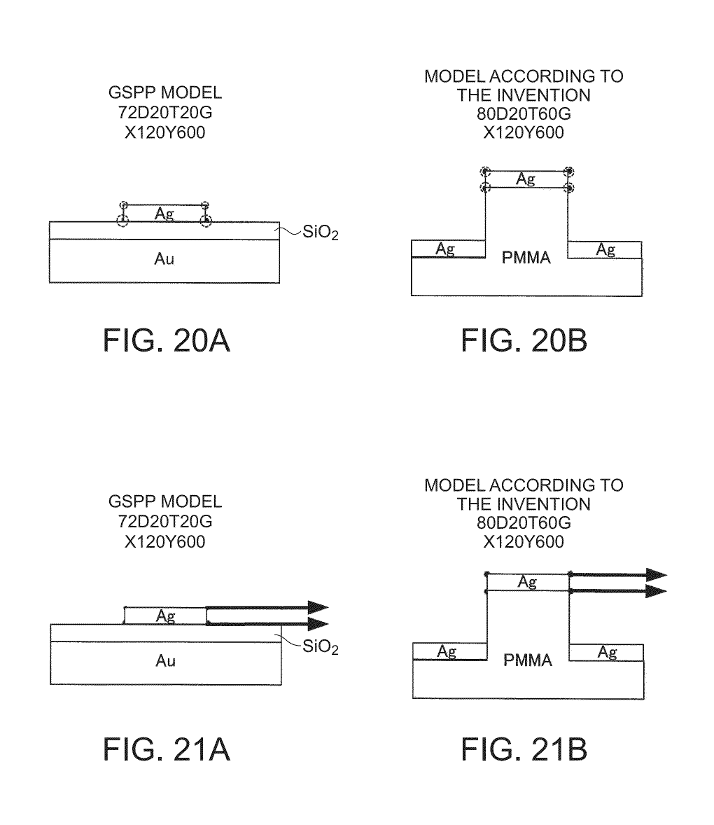

FIGS. 20A-D show a conceptual diagram of the hotspot intensity of the model according to the invention and the GSPP model in the present experimental example. In FIGS. 20A-D, the position and the intensity of each of the hotspots are respectively indicated by the position and the size of the dotted circle.

In the GSPP model, the hotspots with the highest intensity exist in the interface between the Ag particle and the SiO₂ layer below the Ag particle. The enhancement degree is as extremely high as SQRT(Ex²+Ez²)=SQRT(82.02²+103.7²)=132.2. However, in the upper end portion (corresponding to the top end in the invention) of the Ag particle, a value as low as SQRT(Ex²+Ez²)=SQRT(48.3²+52.1²)=71 was obtained. It should be noted that a uniform mesh at a pitch of 1 nm is used in the X, Y directions, and a mesh called “1-5 nm×1.2” grid grating is used in the Z direction.

In contrast, in the model according to the invention, the hotspots with a high intensity exist at two points in the top end and the bottom end of the Ag layer (the second metal layer 30). In the bottom end, SQRT(Ex²+Ez²)=SQRT(65²+59.95²)=88.4 was obtained, while in the top end, SQRT(Ex²+Ez²)=SQRT(65²+69.23²)=95 was obtained. Roughly the same values were obtained in the bottom end and the top end, and these values are each a roughly medium value between the values in the GSPP model described above.

As is understood from FIG. 17, since the reflectance characteristics reflect an integral value of the near field, in the integral value, (model according to the invention)>(GSPP model) is satisfied, and in comparison in total of “(hotspot intensity)×(hotspot density),” the model according to the invention is higher.

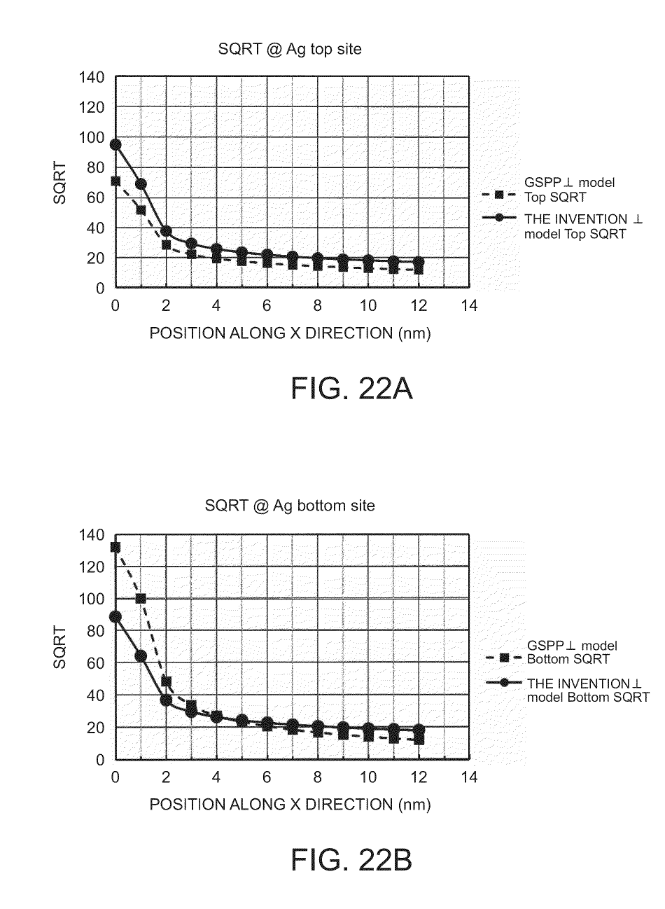

Then, with respect to the single line PSP⊥LSP model according to the invention and the single line PSP⊥LSP model of GSPP, the enhancement degree in the X direction and the distribution of SQRT (Ex²+Ez²) at the positions of the top end and the bottom end of Ag (the second metal layer 30) were examined. FIGS. 21A-B are a pair of schematic diagrams conceptually showing the measurement positions. FIGS. 22A-B are a pair of graphs each showing a distribution of the enhancement degree (SQRT (Ex²+Ez²)) in the X direction defining the end portion (the position of the hotspot) of Ag (the second metal layer 30) as X=0 (i.e., the origin in the X direction corresponds to the interface between Ag (the second metal layer 30) and air).

When looking at FIGS. 22A-B, at the bottom end of Ag (the second metal layer 30), in an area where X is equal to or shorter than 4 nm, the GSPP model is higher in the enhancement degree than the model according to the invention. However, when X exceeds 4 nm, the model according to the invention is higher in enhancement degree than the GSPP model. Further, in the top end of the Ag structure, the model according to the invention is always higher in enhancement degree than the GSPP model irrespective of the value of X.

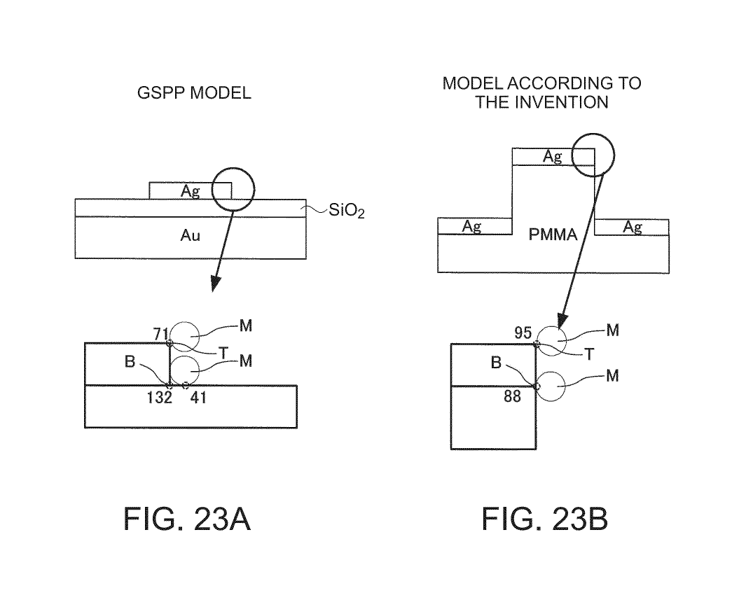

Then, FIGS. 23A-B show the enhancement degree in the region to be attached with a substance when assuming a virtual sample (sensing substance) having a diameter of 5 nm as an example. As shown in the drawing, the sample is not allowed to approach the bottom of the Ag particle of the GSPP single line model. Therefore, the high value of SQRT(Ex²+Ez²)=132 as the enhancement degree of the hotspot in this region cannot be used, and even in the case in which the sample approaches the nearest to the hotspot, it results that the sample is attached to a region about 2.5 nm distant therefrom, and only the enhancement effect of SQRT(Ex²+Ez²)=41 can be expected at the most. Further, although the sample can be attached to the top of the Ag particle of GSPP, the value of SQRT(Ex²+Ez²) at the position is 71 at most, and therefore, it is difficult to expect a significant enhancement effect.

In contrast, in the case of the single line model according to the invention, the sample can be attached to the hotspots in both of the top end and the bottom end, and therefore, the enhancement degrees as high as 95, 88 can efficiently be used, respectively.

### 4.3. Experimental Example 2

### Comparison Between PSP⊥LSP and PSP∥LSP on Single Line Model According to the Invention

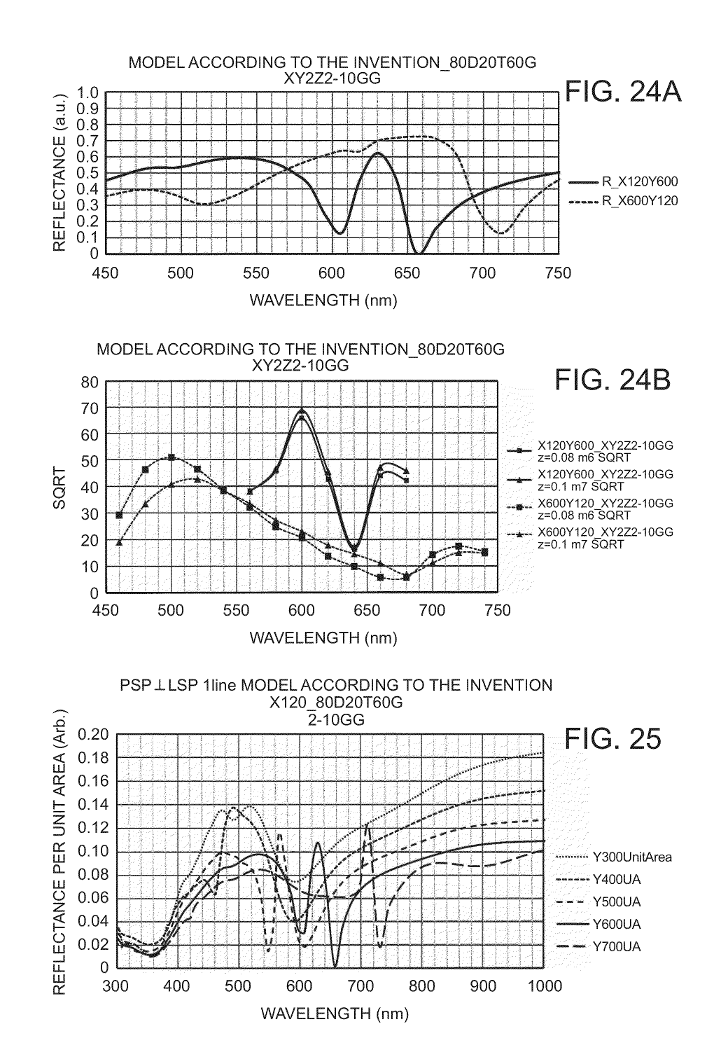

FIGS. 24A-B are a pair of graphs showing the wavelength characteristics in far field and near field of PSP⊥LSP (X120Y600) and PSP∥LSP (X600Y120) of the single line model according to the invention. In other words, the graphs correspond respectively to the data of X120Y600 and X600Y120 in the case of using the excitation light linearly polarized in the X direction.

When looking at FIGS. 24A-B, it is understood that it is sufficient to make the excitation with the linearly-polarized light in the Y direction in the case of expecting to obtain the Raman scattering light with the excitation wavelength of around 500 nm using the same sensing element. Further, it is understood that in the case of expecting to examine the substance with the Raman shift of 1500 cm⁻¹ with the light excited at the wavelength of 600 nm, the Stokes scattering wavelength becomes 659 nm, and the excitation with the linearly-polarized light in the X direction is the optimum. Further, it should be understood that by using the excitation light as circularly-polarized light, there can be obtained a sample analysis element concurrently satisfying the wavelength characteristics of the linearly-polarized light in the X direction and the wavelength characteristics of the linearly-polarized light in the Y direction.

### 4.4. Experimental Example 3

### Dependency of Anticrossing Behavior of Single Line PSP⊥LSP Model According to the Invention on Pitch (PZ2) in Y Direction

Regarding the model having Ag (the second metal layers 30) with 80D20T60G arranged in the X direction at a pitch of 120 nm and in the Y direction at pitches of 300 nm, 400 nm, 500 nm, 600 nm, and 700 nm, respectively, the far field characteristics were examined.

FIG. 25 is a graph showing wavelength characteristics of the reflectance normalized by unit area of the respective models. The present graph shows the reflectance characteristics obtained in the case in which the pitch in the X direction is set to 120 nm and the pitch in the Y direction is set to a variable in the single line PSP⊥LSP model according to the invention. It should be noted that it can be said that the lower the reflectance is, the higher the enhancement degree is.

It is understood that similarly to the disclosure of OPTICS TELLERS (OPTICS TELLERS, Vol. 34, No. 3, 2009, pp. 244-246), the anticrossing behavior is observed in the vicinity of the intersection between PSP and LSP, and a high enhancement degree can be expected at the pitch from Y=400 nm to 700 nm. Further, the lowest reflectance was observed at the Y-direction pitches of 500 nm and 600 nm.

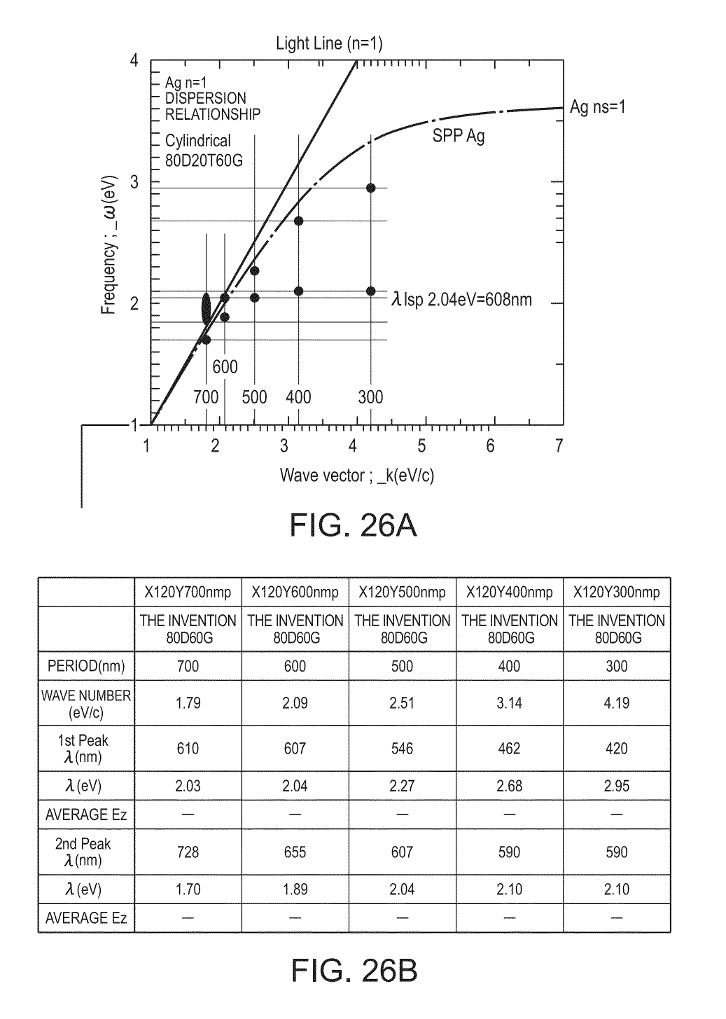

In FIGS. 26A-B, the PSP dispersion relationship of Ag with n=1 is shown with the dotted line, and LSP of the Ag model is shown with the straight line. FIGS. 26A-B show the dispersion relationship obtained by plotting the values of the wavelength, at which the reflectance takes the local minimum value and is read from FIG. 25, on the dispersion relationship of Ag with the surrounding refractive index n=1 for each of the pitches in the Y direction. From the dispersion relationship shown in FIGS. 26A-B, the LSP peak wavelength was estimated to be 608 nm.

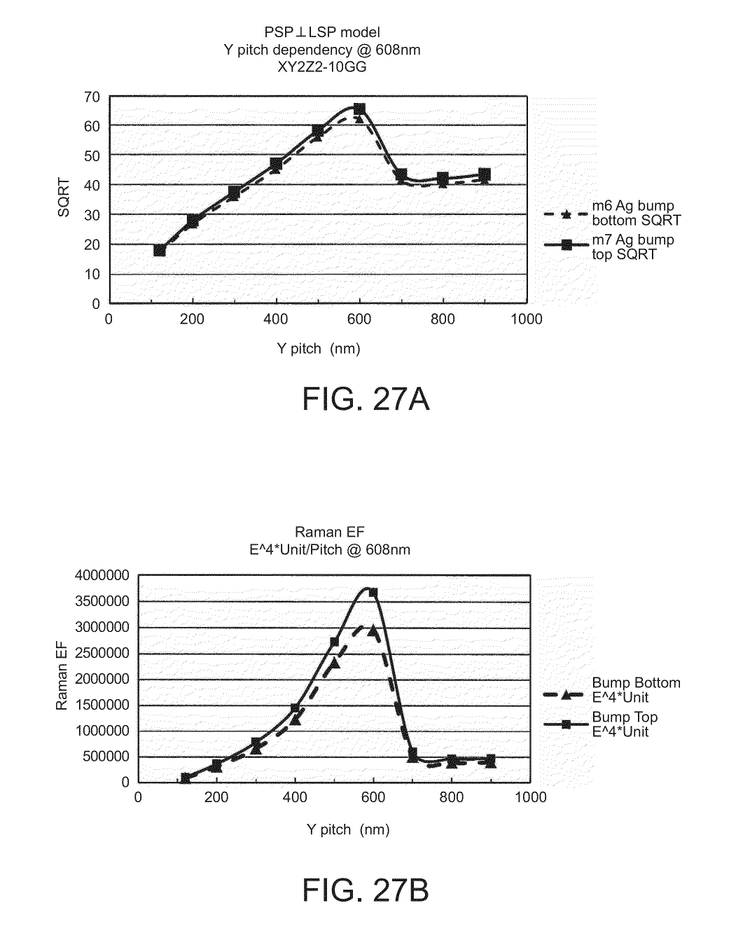

Therefore, there were obtained the near field characteristics in the case of setting the excitation wavelength to 608 nm, and arranging Ag (the second metal layers 30) each having the shape of 80D20T60G while fixing the pitch in the X direction to 120 nm, and varying the pitch in the Y direction by 100 nm in a range from 200 nm to 900 nm. The results are shown in FIGS. 27A-B. FIGS. 27A-B are a pair of graphs obtained by plotting SQRT(Ex²+Ez²) and the Raman EF, respectively, when setting the excitation wavelength to 608 nm, and gradually increasing the pitch in the Y direction from Y=120 nm corresponding to the basic model.

It is understood that in the basic structure at X120Y120, the enhancement degree SQRT(Ex²+Ez²)=17.9 is obtained on the top end of Ag (the second metal layer 30) on the one hand, when increasing the pitch in the Y direction, the enhancement degree linearly increases, and then becomes the maximum at the Y pitch=600 nm, at which it is designed that the curve passes through the intersection between the peak wavelength of the LSP of Ag (the second metal layer 30) and the PSP of the Ag layer (the first metal layer 10), then decreases by half at the Y pitch=700 nm, and then rises gradually. The reason that the enhancement degree shows such a pitch dependency is that the Y-direction pitch=600 nm corresponds to the case of m=1 in the diffraction grating, and the case of m=2 corresponds to the Y-direction pitch=1200 nm. However, since the hotspot density is lowered as the Y-direction pitch increases, the Raman EF becomes a roughly constant value in the area with the Y-direction pitch is longer than 700 nm as shown in FIGS. 27A-B.

The reason that in the single line PSP⊥LSP model, the enhancement degree in the case of P2>120 nm is higher than the enhancement degree in the case of P=P2=120 nm is that the LSP occurs in the polarization direction of the excitation light, and the PSP occurs in all directions, and therefore, the PSP generated in an oblique direction, in which the pitch of 600 nm is realized, exerts the hybrid effect even in the case in which the Y-direction pitch is shorter than 600 nm.

The facts described above show that in the case of the normal incidence, when the P1=120 nm is set, the Raman EF becomes stronger than that of the basic model in the range of 120 nm<P2<800 nm, than FIGS. 27A-B. In other words, it has been found out that by satisfying P1<P2≦Q+P1, the strong Raman EF can be obtained.

It should be noted that the experiments described above correspond to the case in which the incident light perpendicularly enters the substrate. The case in which the incident light obliquely enters the substrate will hereinafter be described.

As described in the section of “1.4.1. Propagating Surface Plasmon and Localized Surface Plasmon,” the dispersion relational expression of a certain metal is provided as follows assuming that the dielectric constant of the metal as ε(ω), and the surrounding dielectric constant as ε.

K_{SPP}=ω/c{ε·ε(ω)/(ε+ε(ω))}^{1/2} (3)

Meanwhile, the wave number K of the evanescent light passing through the diffraction grating with the pitch Q is obtained by the following expression.

K=n·(ω/c)·sin θ+m·2π/Q (m=±1, ±2, . . . ) (4)

It should be noted that since the dielectric constant is ε=n²−κ², and κ=0 is true for the case of the insulating body, the surrounding diffractive index n and the square-root of the surrounding dielectric constant are in the relationship of n=ε^{1/2}.

When the wave number of the dispersion relationship of the metal and the wave number of the evanescent wave of the incident wave become equal to each other, the propagating surface plasmon is generated. In other words, since K_{SPP}=K is true, by arranging the metal particles so that the pitch Q satisfies Formula 2 obtained from Formula 3 and Formula 4, the propagating surface plasmon is excited.

(ω/c)·{ε·ε(ω)/(ε+ε(ω))}^{1/2}=ε^{1/2}·(ω/c)·sin θ+2mπ/Q (m=±1, ±2, . . . ) (2)

Formula 2 is the general expression expressing the intersection between the dispersion relationship of the propagating surface plasmon of the metal layer and the evanescent light due to the diffraction-grating effect exerted by the metal particles periodically arranged directly or indirectly. It should be noted that in the case of the normal incidence used for the simulation, θ=0 is true, and therefore Formula 2 becomes as follows, and the diffraction-grating wave number at which the dispersion relationship of the metal layer and the wave number of the evanescent light due to the diffraction-grating effect provided by the metal particles coincide with each other becomes m·2π/Q.

(ω/c)·{ε·ε(ω)/(ε+ε(ω))}^{1/2}=2mπ/Q (m=±1, ±2, . . . ) (7)

For example, in the case of m=1, n=1, and 30-degree incidence, Formula 4 becomes as follow, and the diffraction-grating pitch in the case of the 30-degree incidence passing through the intersection with the Ag dispersion relationship at the LSP=633 nm becomes 1 eV/c, and therefore, it is sufficient to set the diffraction-grating pitch Q to 1250 nm.

K=0.5·(ω/c)+2π/Q (8)

Further, on the other hand, assuming θ=−30° (deg), Formula 4 becomes as follows, and in order to pass through the intersection between the LSP and the dispersion relationship of Ag (n=1), 2π/Q=3 eV/c, namely Q=418 nm is obtained.

K=−0.5·(ω/c)+2π/Q (9)

FIGS. 28A-B show the dispersion relationship for determining the diffraction-grating pitch using the excitation light beams of the 30-degree incidence and the −30-degree incidence described above.

Since the +30-degree incidence and the −30-degree incidence are physically equivalent to each other, it is understood that in the case of using the oblique incident light with the incident angle of +30 degrees, when selecting the pitch of the diffraction grating so that the line passes through the intersection between the LSP of 633 nm and the dispersion relationship of Ag (n=1), there are two ways, namely setting the diffraction-grating pitch to Q=1250 nm and setting the diffraction-grating pitch to Q=418 nm.

As a result, similarly to the case of the normal incidence, even in the case of the oblique incidence, the sample analysis element stronger in the Raman EF than the basic model is obtained provided that the following relationship is satisfied.

P1<P2≦Q+P1 (1)

### 4.5. Experimental Example 4

### Height and Shape of Second Metal Layer

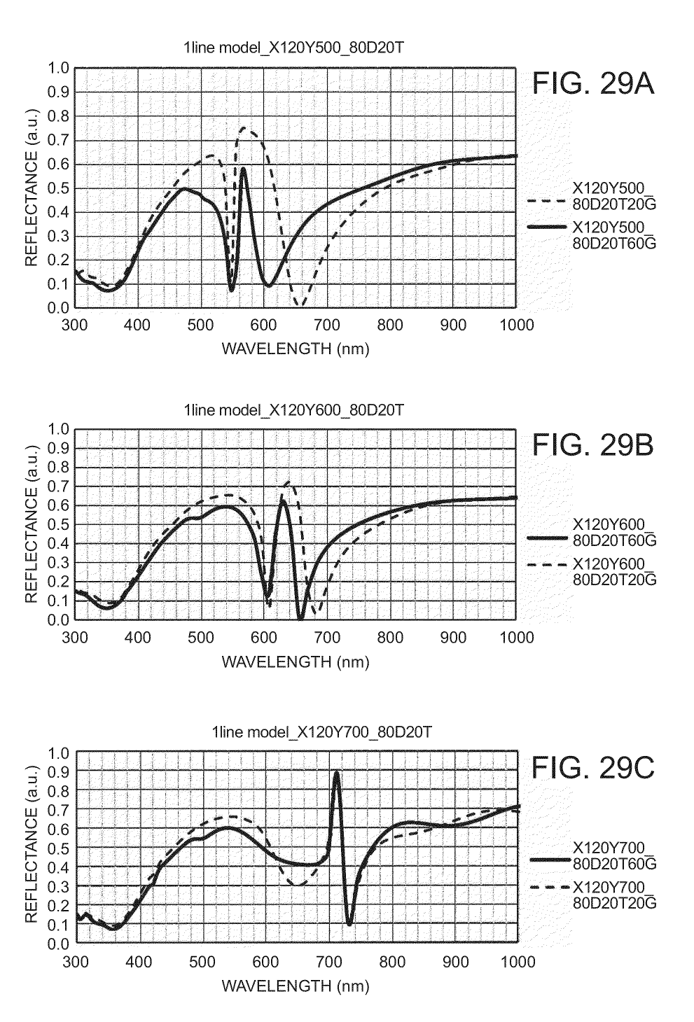

An experiment in the case of decreasing the height of the second metal layer 30 from 60G to 20G was performed in the single line PSP⊥LSP model according to the invention. FIGS. 29A-C are a set of graphs showing the reflectance characteristics in the cases in which the gap G was set to 20 nm and 60 nm, respectively, in each of the cases in which the Y-direction pitch was set to 500, 600, and 700 nm, respectively, in the single line PSP⊥LSP model according to the invention.

As shown in FIGS. 29A-C, when the height of the second metal layer 30 is decreased (the gap G is reduced), the interaction of the LSP between the second metal layer 30 and the first metal layer 10 becomes stronger, and in both of the cases of setting the Y-direction pitch to 500 nm and 600 nm, respectively, the red shift of the peak wavelength of the LSP is larger in the case of 20G than in the 60G model.

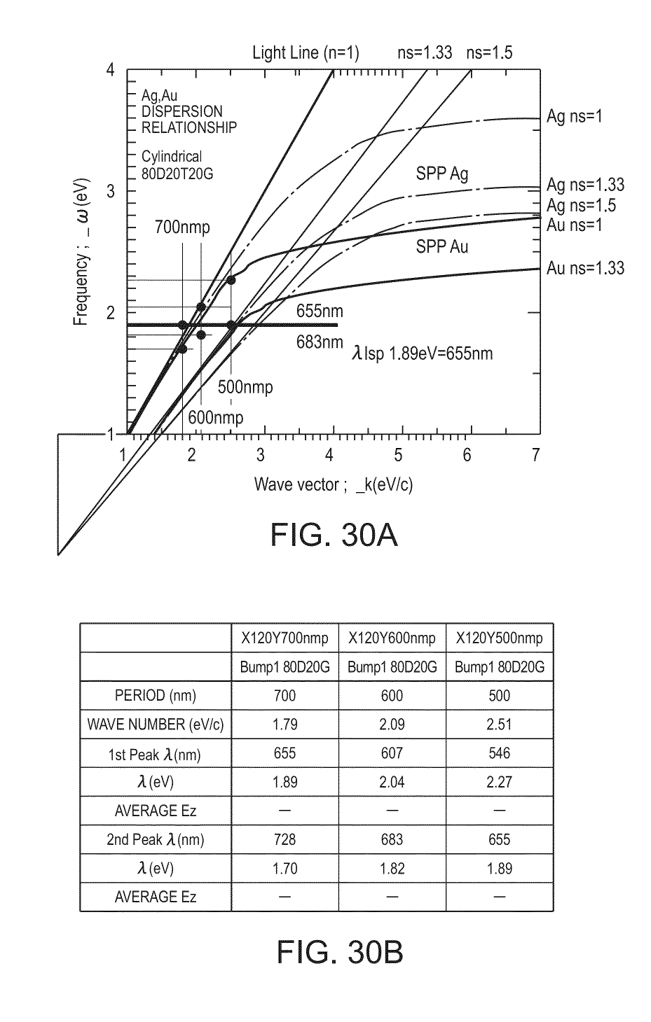

FIGS. 30A-B are a plot of the wavelength with the local minimum value of the reflectance in the case of the gap=20 nm shown in FIGS. 29A-C on the dispersion relationship of Ag (n=1). As a result of performing the plot on the dispersion relationship, according to FIGS. 30A-B, the peak wavelength of the LSP can be estimated to be 655 nm (608 nm in the case of 60G).

### 4.6. Experimental Example 5

### Influence of Second Metal Particle Row

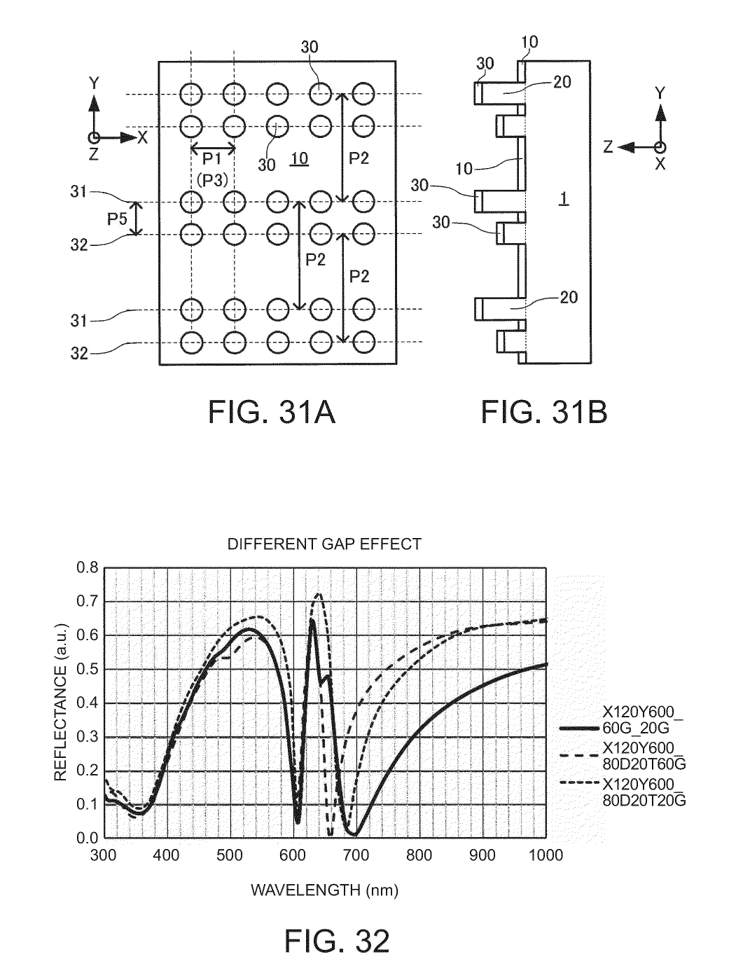

Then, the enhancement degree in the case of arranging the second metal rows 32 will be described. FIGS. 31A-B schematically show a model having the second metal rows 32 each constituted by the second metal layers 30 arranged with gaps G different from the gaps G of the second metal layers 30 belonging to the first metal row 31. FIG. 32 shows the reflectance characteristics of the PSP⊥LSP models, specifically the single line model with the gaps of 20 nm, the single line model with the gaps of 60 nm, and the model having the metal particle rows with two types of gaps including the gaps of 20 nm and the gaps of 60 nm in the same plane.

FIG. 32 shows that in the far field characteristics in the case of arranging the two metal particle rows respectively with 20G and 60G in X120Y600, there exist three peaks. It is understood that each of the three peaks is a combination of the reflectance characteristics of the single line with 20G and the reflectance characteristics of the single line with 60G.

The peak at 607 nm is common to all of the models, and is conceivably a principal peak of the PSP formed at the pitch of P2=600 nm. In contrast, each of the peaks appearing in a range equal to or longer than 640 nm is reasonably thought to be a principal peak of the LSP formed by the gaps of 20G and 60G, and is subject to the red shift in the models with 20G shorter than 60G.

Therefore, it was understood that the extremely strong Raman EF can be obtained in the sample which generates the Raman scattering wavelength at 643 nm and 697 nm assuming the Raman excitation wavelength as 607 nm.

Further, by changing the diameter D in the planar view of the second metal layer 30 as shown in FIGS. 33A through 33C, the peak wavelength of the LSP is also changed. When the diameter D increases, the red shift is caused in the peak wavelength of the LSP. An elliptical shape, a prismatic shape, a triangular shape, and an asteroid shape can also be adopted. FIGS. 33A, 33B, and 33C show a variety of models in which the pitch P2 is fixed, and the diameter and the shape (an elliptical shape, a prismatic shape) of the cylinder are changed in the same plane.

In either of the examples shown in FIGS. 33A through 33C, when the Y-direction pitch of the cylinders, the Y-direction pitch of the ellipses, or the Y-direction pitch of the prisms is set to the pitch (P2) at which the PSP is enhanced, there are observed the two peaks, namely the principal peak of the PSP and the principal peak of the LSP for each of the shapes due to the hybrid effect, and since the second metal layers 30 are arranged in the Y direction at the pitch P2 in all shapes, the principal peak of the PSP is unique and the same between the shapes.

In contrast, regarding the principal peak of the LSP, since the size, the distance, the gap, and the shape of the second metal layers 30 are changed, a plurality of peaks appears in some cases. For example, in the example shown in FIG. 33A, a design for using one excitation wavelength and two Raman scattering wavelengths is possible, and in the examples shown in FIGS. 33B and 33C, a design for using one excitation wavelength and three Raman scattering wavelengths is possible.

It should be noted that in the examples shown in FIGS. 33B and 33C, the two types of second metal rows 32 are disposed, and such configurations, it can be assumed that three types of metal rows exist. For example, one of the types of the second metal rows 32 can be regarded as the second metal rows 32, and the other of the types of the second metal rows 32 can be regarded as third metal rows 33. In such a case, it can be said that in the examples shown in FIGS. 33B and 33C, similarly to the case of the second metal rows 32, the third metal rows 33 are arranged in the second direction at the second pitch P2, and are arranged together with the first metal rows 31 alternately side by side in the second direction.

From such a viewpoint, it can be said that in FIGS. 33B and 33C, there are included the second metal rows 32 each having the plurality of second metal layers 30 arranged side by side in the first direction at the third pitch P3 and the third metal rows 33 each having the plurality of second metal layers 30 arranged side by side in the first direction at the fourth pitch P4, and the second metal rows 32 and the third metal rows 33 are disposed so as to be respectively arranged in the second direction at the second pitch P2 and at the same time arranged alternately with the first metal rows 31, and at least one of the shape, the dimension, and the height of the location of the second metal layer 30 is different between the second metal layers 30 belonging respectively to the first metal rows 31, the second metal rows 32, and the third metal rows 33.

The pitch P5 and the pitch P6 shown in FIGS. 33B and 33C represent the pitch between the second metal row 32 and the first metal row 31 and the pitch between the third metal row 33 and the first metal row 31, respectively, in the second direction. The third metal row 33 can be the same in configuration as the first metal row 31, or can be different in configuration from the first metal row 31. The distance (the pitch P6) in the second direction between the third metal row 33 and the first metal row 31 can be a size no lower than 1% and no higher than 50% of the pitch P2. Further, the pitch P6 can be set independently of the pitch P1 in the first direction of the second metal layers 30. Further, the pitch P6 can be the same as pitch P5, or can also be different from the pitch P5.

It should be noted that in the examples shown in FIGS. 33B and 33C, although the description is presented assuming that the pitch P3 in the second metal row 32 and the pitch P4 in the third metal row 33 are roughly the same, the pitch P4 in the third metal row 33 can be the same as, or can also be different from, the pitch P1 of the first metal row 31 or the pitch P3 in the second metal row 32 similarly to the case of the pitch P3 in the second metal row 32 having already been described.

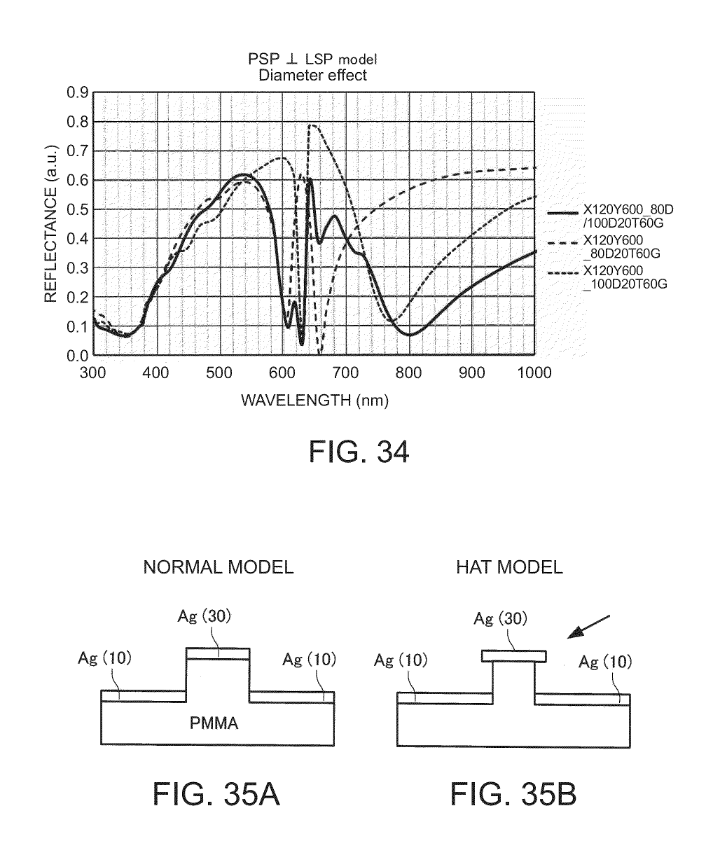

FIG. 34 shows the reflectance characteristics when arranging the second metal layers 30 having two types of diameters (D) in the single line PSP⊥LSP models. Among the models shown in FIG. 34, in 80D models, the local minimum value on the short wavelength side and the local minimum value on the long wavelength side cause the anticrossing behavior due to the hybrid between the PSP and the LSP. In contrast, in the 100D model, it is conceivable that the local minimum value on the short wavelength side corresponds to the peak derived mainly from the PSP, and the broad local minimum value on the long wavelength side corresponds to the local minimum value derived mainly from the LSP. In the 100D model, since the distance between the second metal layers 30 is as short as 20 nm, the red shift occurs in the peak wavelength of the LSP. In either case, it was found out that the mixture model of 80D and 100D became the combination of the 80D model and the 100D model, and was provided with the four minimum values.

The Raman scattering of the sample causes a number of Raman shifts depending on the types and the vibration direction of the molecule of the sample. Specifically, the wavelength after the Raman shift varies from several tens of nanometers to several hundreds of nanometers with respect to one sample. Moreover, a plurality of wavelength shifts is caused. In other words, a plurality of scattering wavelengths is provided. By obtaining a number of Raman shifts, the identification probability of the sample is dramatically increased. Therefore, as is obvious from the present experimental example, according to the optical element of the invention, the design suitable for the excitation wavelength and the plurality of scattering wavelengths can easily be realized, and thus the accuracy of the sample analysis can dramatically be improved.

### 4.7. Experimental Example 6

### Overlap in Planar View Between Second Metal Layer and First Metal Layer

For example, if the second metal layers 30 are formed by performing Ag evaporation and so on, overhangs occur in some cases as shown in the right drawing of FIGS. 35A-B. Further, it is also possible to intentionally form a configuration of the overhangs. In the configuration of the overhangs, the second metal layer 30 and the first metal layer 10 have overlaps in the planar view. Therefore, a model (hereinafter referred to as a hat model in some cases) having the dielectric columns changed in size to 60D40T and keeping the size of the second metal layers 30 in 80D20T was calculated, and the difference between the hat model and the model (hereinafter referred to as a normal model in some cases) according to the invention was examined.

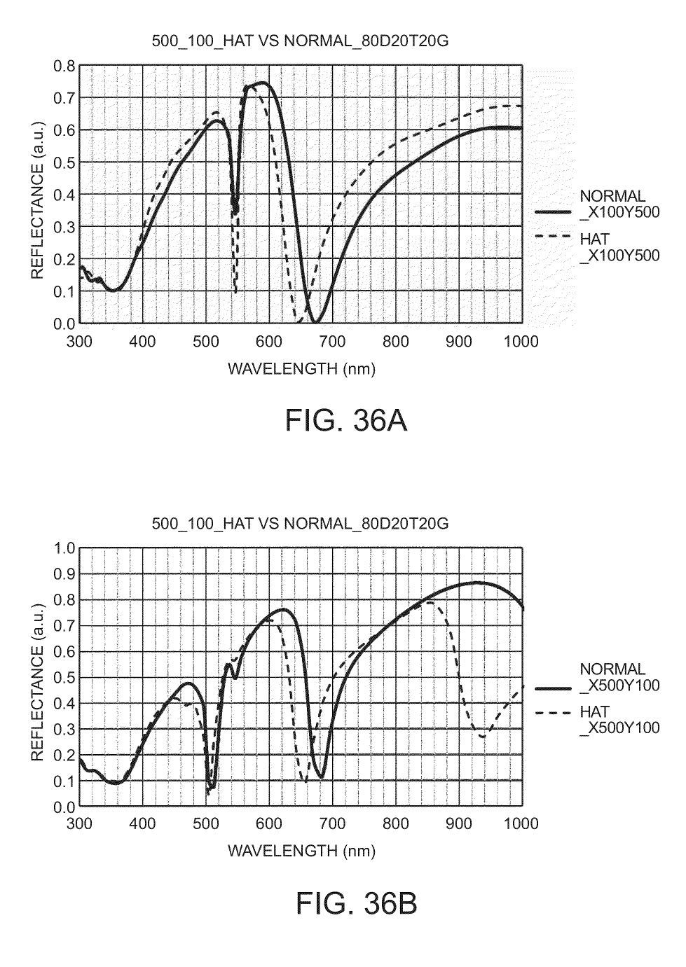

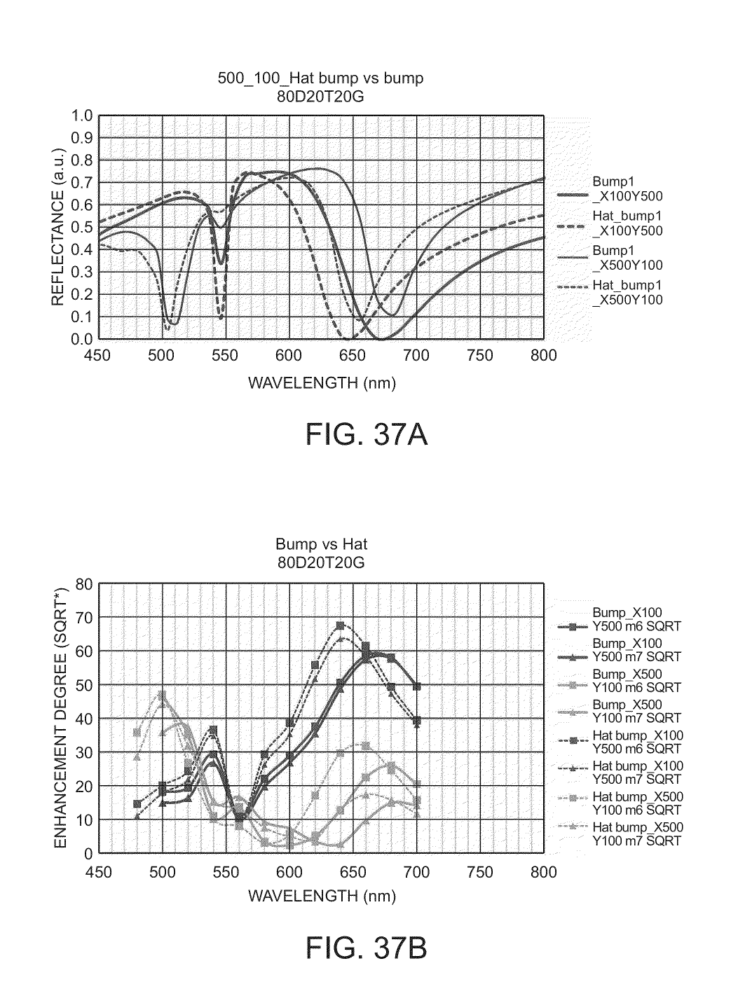

FIGS. 36A-B show the reflectance characteristics of the normal model and the hat model. FIGS. 37A-B show the correlation between the far field and the near field in the normal model and the hat model.

According to FIGS. 36A-B and 37A-B, compared to the normal model, in the hat model, the blue shift occurred in the wavelength (the broad reflectance characteristic on the long wavelength side) of the LSP peak in the single line PSP⊥LSP model and the single line PSP∥LSP model. According to the near field characteristics, the hat model is stronger in enhancement degree than the normal model. However, both models show roughly the same tendency except these points. Therefore, it became clear that even if the normal model became similar to the hat model due to the variation in, for example, deposition of Ag, the advantage of the invention was not lost.

### 4.8. Experimental Example 7

### Dielectric Column Not Penetrating First Metal Layer

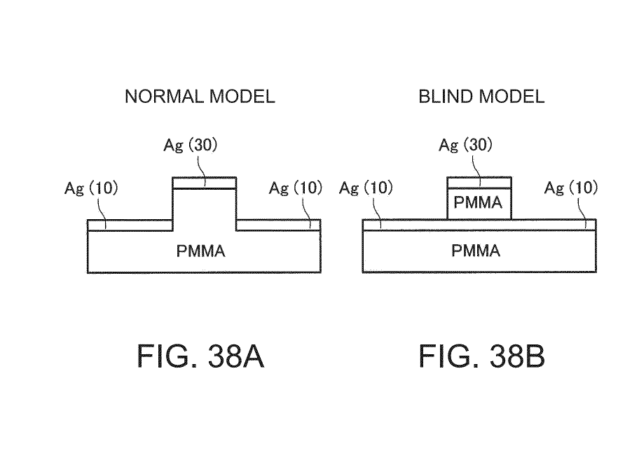

Regarding the structure in which the dielectric column 20 did not penetrate the first metal layer 10, the enhancement degree was examined. Specifically, the enhancement degree was examined using the structure (the left drawing (the normal model) of FIGS. 38A-B) according to the invention and a blind model (the right drawing of FIGS. 38A_B) having a structure different only in the point that no hole is provided to the first metal layer 10. In the blind model, the dielectric column 20 and the first metal layer 10 exist below the second metal layer 30. FIGS. 38A-B schematically show the model with the structure according to the invention and the blind model.

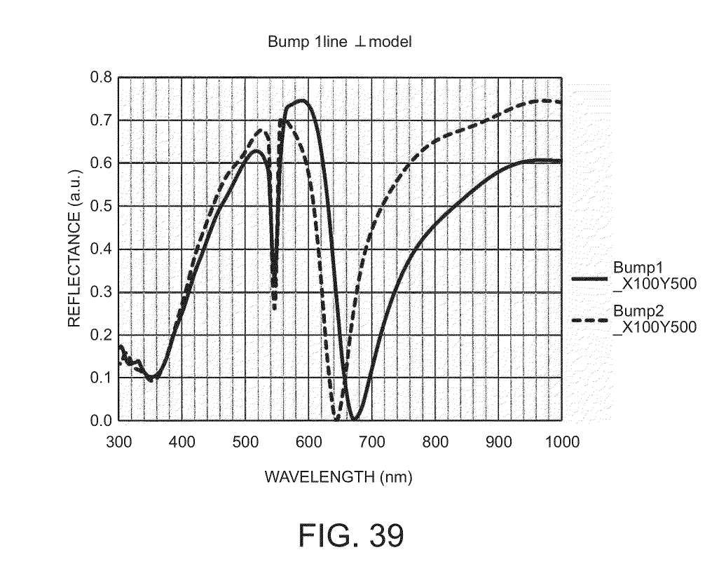

FIG. 39 is a graph showing the far field characteristics of the model with the structure according to the invention and the blind model. According to FIG. 39, the local minimum value was roughly equal between both models, and the blue shift occurred in the broad reflectance characteristics on the long wavelength side in the single line PSP⊥LSP model of the blind model compared to the normal model, but both models showed roughly the same tendency except these points. Further, in view of the fact that the blind model shown in FIG. 39 exhibited roughly the same reflectance characteristics as those of the hat model shown in the drawing of FIGS. 36A-B, it is conceivable that the same physical phenomenon was exhibited due to the overlap between the second metal layer 30 and the first metal layer 10 in the planar view.

The invention is not limited to the embodiment described above, but can further be variously modified. For example, the invention includes configurations (e.g., configurations having the same function, the same way, and the same result, or configurations having the same object and the same advantage) substantially the same as the configuration described as the embodiment. Further, the invention includes configurations obtained by replacing a non-essential part of the configuration described as the embodiment. Further, the invention includes configurations providing the same functions and the same advantage, or configurations capable of achieving the same object, as the configuration described as the embodiment. Further, the invention includes configurations obtained by adding a known technology to the configuration described as the embodiment.

The entire disclosure of Japanese Patent Application No. 2013-187209 filed Sep. 10, 2013 is expressly incorporated by reference herein.

What is claimed is:

1. An analysis device comprising:
an optical element including:
a first metal layer, and
second metal layers respectively disposed on dielectric columns supported by the first metal layer, the second metal layers being electrically insulated from the first metal layer,
wherein the second metal layers form a plurality of first metal rows each constituted by the second metal layers arranged in a first direction at a first pitch, the first metal rows have a second pitch in a second direction intersecting with the first direction;
a light source adapted to irradiate the optical element with incident light; and
a detector adapted to detect light emitted from the optical element irradiated with the incident light,
wherein the second metal layers satisfy Formula 1:
P1<P2≦Q+P1 (1)
wherein, P1 represents the first pitch, P2 represents the second pitch, and Q represents a pitch of a diffraction grating provided by Formula 2:
(ω/c)·{ε·ε(ω))}^{1/2}=ε^{1/2}·(ω/c)·sin θ+2mπ/Q (m=±1, ±2, . . . ) (2)
wherein an angular frequency of a localized surface plasmon excited in the second metal layers is ω, a dielectric constant of metal constituting the first metal layer is ε(ω), a surrounding dielectric constant of the first metal layer is ε, a velocity of light in vacuum is c, and a tilt angle from a thickness direction of the first metal layer as an irradiation angle of the incident light is θ.

2. The analysis device according to claim 1, wherein
the dielectric columns are formed on the first metal layer.

3. The analysis device according to claim 1, wherein
the dielectric columns penetrate the first metal layer.

4. The analysis device according to claim 1, wherein
the optical element includes a plurality of second metal rows each constituted by the second metal layers arranged in the first direction at a third pitch, and
the second metal rows are disposed so as to be arranged in the second direction at the second pitch alternately with the first metal rows.

5. The analysis device according to claim 4, wherein
the first pitch and the third pitch are equal to each other, and
the second metal layers belonging to the first metal rows and the second metal layers belonging to the second metal rows have the same shape, dimensions, and height of location.

6. The analysis device according to claim 4, wherein
the second metal layers belonging to the first metal rows and the second metal layers belonging to the second metal rows are different from each other in at least one of shape, dimensions, and height of location.

7. The analysis device according to claim 1, wherein
the optical element includes a plurality of second metal rows each constituted by the second metal layers arranged in the first direction at a third pitch, and a plurality of third metal rows each constituted by the second metal layers arranged in the first direction at a fourth pitch,
the second metal rows and the third metal rows are each disposed so as to be arranged in the second direction at the second pitch alternately with the first metal rows, and the second metal layers belonging respectively to the first metal rows, the second metal rows, and the third metal rows are different from each other in at least one of shape, dimensions, and height of location.

8. The analysis device according to claim 1, wherein
the incident light is linearly-polarized light in a direction identical to the first direction.

9. The analysis device according to claim 1, wherein
the incident light is linearly-polarized light in a direction identical to the second direction.

10. The analysis device according to claim 1, wherein
the incident light is circularly-polarized light.

11. The analysis device according to claim 1, wherein
the detector detects Raman scattering light enhanced by the optical element.

12. An optical element comprising:
a first metal layer; and
a plurality of second metal layers respectively disposed on dielectric columns supported by the first metal layer, the second metal layers being electrically insulated from the first metal layer,
wherein the second metal layers form a plurality of first metal rows each constituted by the second metal layers arranged in a first direction at a first pitch, the first metal rows have a second pitch in a second direction intersecting with the first direction, and
the second metal layers satisfy Formula 1:
P1<P2≦Q+P1 (1)
wherein, P1 represents the first pitch, P2 represents the second pitch, and Q represents a pitch of a diffraction grating provided by Formula 2:
(ω/c)·{ε·ε)/(ε+ε(ω))}^{1/2}=ε^{1/2}·(ω/c)·sin θ+2mπ/Q (m=±1, ±2, . . . ) (2)
wherein an angular frequency of a localized surface plasmon excited in the second metal layers is ω, a dielectric constant of metal constituting the first metal layer is ε(ω), a surrounding dielectric constant of the first metal layer is ε, a velocity of light in vacuum is c, and a tilt angle from a thickness direction of the first metal layer as an irradiation angle of the incident light is θ.

13. The analysis device according to claim 12, wherein
the dielectric columns are formed on the first metal layer.

14. The analysis device according to claim 12, wherein
the dielectric columns penetrate the first metal layer.

15. An analysis method comprising:
irradiating an optical element with incident light;
detecting light emitted from the optical element in accordance with the irradiation with the incident light; and
analyzing an object attached to a surface of the optical element,
wherein the optical element includes:
a first metal layer, and
a plurality of second metal layers respectively disposed on dielectric columns supported by the first metal layer, the second metal layers being electrically insulated from the first metal layer,
wherein the second metal layers form a plurality of first metal rows each constituted by the second metal layers arranged in a first direction at a first pitch, the first metal rows have a second pitch in a second direction intersecting with the first direction, and
the second metal layers satisfy Formula 1:
P1<P2≦Q+P1 (1)
wherein, P1 represents the first pitch, P2 represents the second pitch, and Q represents a pitch of a diffraction grating provided by Formula 2:
(ω/c)·{ε·ε(ω)/(ε+ε(ω))}^{1/2}=ε^{1/2}·(ω/c)·sin θ+2mπ/Q (m=±1, ±2, . . . ) (2)
wherein an angular frequency of a localized surface plasmon excited in the second metal layers is ω, a dielectric constant of metal constituting the first metal layer is ε(ω), a surrounding dielectric constant of the first metal layer is ε, a velocity of light in vacuum is c, and a tilt angle from a thickness direction of the first metal layer as an irradiation angle of the incident light is θ.

16. The analysis method according to claim 15 wherein
the dielectric columns are formed on the first metal layer.

17. The analysis method according to claim 15 wherein
the dielectric columns penetrate the first metal layer.

18. An electronic apparatus comprising:
the analysis device according to claim 1;
an operation section adapted to perform an operation on information based on detection information from the detector;
a storage section adapted to store the information; and
a display section adapted to display the information.

19. The electronic apparatus according to claim 18, wherein
the information is health medical information.

20. The electronic apparatus according to claim 19, wherein
the health medical information includes information related to one of presence or absence and an amount of one of at least one biologically-relevant substance selected from a group consisting of bacteria, a virus, a protein, a nucleic acid, and an antigen/antibody, and at least one compound selected from an inorganic molecule and an organic molecule.
